(19) United States
(12) Patent Application Publication
(10) Pub. No.: US 2026/0364483 A1
(43) Pub. Date: Nov. 19, 2026

(54) METHODS, SYSTEMS AND APPARATUS FOR PROCESSING GASEOUS STREAMS INCLUDING CARBON DIOXIDE

(71) Applicants: Miles L. Lindsey Abarr, Boulder, CO (US); Christopher Stephen Bence, Beaverton, OR (US); Ethan James Markey, Englewood, CO (US); Jeffrey Michael Young, Boulder, CO (US)

(72) Inventors: Miles L. Lindsey Abarr, Boulder, CO (US); Christopher Stephen Bence, Beaverton, OR (US); Ethan James Markey, Englewood, CO (US); Jeffrey Michael Young, Boulder, CO (US)

(73) Assignee: FrostCarbon, Inc., (omitted)

(21) Appl. No.: 19/715,849

(22) Filed: Jun. 22, 2026

Related U.S. Application Data
(63) Continuation of application No. PCT/US2025/022335, filed on Mar. 31, 2025.
(60) Provisional application No. 63/572,846, filed on Apr. 1, 2024.

(51) Int. Cl. B01D 7/00; F25J 3/02

(52) U.S. Cl. CPC B01D 7/00; F25J 3/0266

(57) ABSTRACT

Apparatus, systems, and methods for processing gaseous streams including CO₂ are disclosed. A method for performing a hot compression on a gaseous input stream including carbon dioxide (CO₂) involves mixing the gaseous input stream with at least a portion of a CO₂ depleted gaseous stream to generate a gaseous input stream having a CO₂ concentration that meets a target CO₂ concentration. Another method involves compressing the gaseous input stream in a hot compressor to generate a hot compressed gaseous stream and extracting thermal energy from the hot compressed gaseous stream for storage in a thermal energy store. An apparatus for cooling and compressing a hot compressed gaseous stream to facilitate removal of carbon dioxide (CO₂) from the stream is also disclosed. A CO₂ separator apparatus for extracting carbon dioxide (CO₂) from a cold compressed gaseous stream is also disclosed.

### FIELD

This disclosure relates generally to processing gaseous streams that include carbon dioxide (CO₂) and more particularly to processing gaseous streams to remove CO₂.

### BACKGROUND

Many industrial processes have the undesirable side-effect of emitting gaseous streams that include increased concentrations of CO₂ over the naturally occurring CO₂ fraction in atmosphere. Additionally, it may also be desirable to remove CO₂ from atmospheric air to offset previous and/or current excess CO₂ emissions by industry, transportation infrastructure, construction, and other human activities.

Gaseous CO₂ may be removed from a gaseous stream through the use of absorbents such as amines. Other methods for removal of gaseous CO₂ may involve cooling to cryogenic conditions where the gaseous CO₂ goes through a phase change to a solid, which may then be separated from the gaseous stream as either a liquid or solid.

### SUMMARY

Embodiments disclosed herein provide methods, devices, systems, and techniques for extracting CO₂ from a compressed gaseous stream. A system as disclosed herein may include, for example, a first heat exchanger that further cools the compressed gaseous stream to cause desublimation of CO₂ and produce a CO₂ depleted gaseous stream; and an expander to expand the CO₂ depleted gaseous stream while extracting mechanical work, thereby cooling the CO₂ depleted gaseous stream. The CO₂ depleted gaseous stream may then be used as a coolant for cooling the first heat exchanger. The system may also include a second heat exchanger between the first heat exchanger and the expander, which reheats the CO₂ depleted gaseous stream prior to delivery to the expander to reduce formation of solids within the expander. The cold compressed gaseous stream may be received from a recuperative heat exchanger that precools and compresses the stream. The CO₂ depleted gaseous stream may be returned to the recuperative heat exchanger after being used as a coolant to recuperatively warm the CO₂ depleted gaseous output stream.

Embodiments disclosed herein also provide methods, devices, systems, and techniques for extracting carbon dioxide (CO₂) from a cold compressed gaseous stream, which may include a first heat exchanger connected to receive and further cool the cold compressed gaseous stream to cause desublimation of CO₂ within the first heat exchanger and to produce a CO₂ depleted gaseous stream at an outlet of the first heat exchanger. The system may also include an expander connected to the outlet of the first heat exchanger and configured to expand the CO₂ depleted gaseous stream while extracting mechanical work thereby further cooling the CO₂ depleted gaseous stream and a frost catcher connected to receive the further cooled CO₂ depleted gaseous stream from the expander. The frost catcher may be configured to cause further desublimation of remaining CO₂ within the CO₂ depleted gaseous stream, the frost catcher having an outlet for discharging the further cooled CO₂ depleted gaseous stream for use as a coolant in cooling the first heat exchanger.

Embodiments disclosed herein also provide methods, devices, systems, and techniques for performing a hot compression on a gaseous input stream including carbon dioxide (CO₂). A method as disclosed herein may involve compressing the gaseous input stream in a hot compressor to generate a hot compressed gaseous stream, extracting thermal energy from the hot compressed gaseous stream for storage in a thermal energy store, and using stored thermal energy in the thermal energy store to generate steam for use in a steam driven process.

Embodiments disclosed herein may also provide methods, devices, systems, and techniques for performing a hot compression on a gaseous input stream including carbon dioxide (CO₂). A method may involve mixing the gaseous input stream with at least a portion of a CO₂ depleted gaseous stream to generate a gaseous input stream having a CO₂ concentration that meets a target CO₂ concentration, the target CO₂ concentration being associated with efficient operation of at least one downstream processing stage. The method may also involve compressing and cooling the gaseous input stream in a hot compressor to generate a hot compressed gaseous stream, and delivering the hot compressed gaseous stream for downstream processing to generate the CO₂ depleted gaseous stream.

Embodiments disclosed herein may also provide devices, systems, and techniques for cooling and compressing a hot compressed gaseous stream to facilitate removal of carbon dioxide (CO₂) from the stream, in a downstream process. A system may include a multi-stream heat exchanger including a plurality of fluid flow passages, each passage being in thermal communication with at least one other passage in the plurality of passages, the plurality of fluid flow passages including at least one inlet passage connected to receive the hot compressed gaseous stream. The system may also include a compressor connected to receive the hot compressed gaseous stream from the at least one inlet passage, the compressor being configured to compress the stream and to discharge the compressed gaseous stream via at least one outlet passage in the plurality of fluid flow passages. At least some of the plurality of fluid flow passages of the multi-stream heat exchanger may be connected to receive a coolant flow for cooling the hot gaseous stream flowing through the at least one inlet passage and for cooling the compressed gaseous stream discharged via the at least one outlet passage.

Embodiments disclosed herein may also provide devices, systems, and techniques for compressing a gaseous input stream including carbon dioxide (CO₂). A system may include a plurality of compressors each configured to successively compress the gaseous input stream to generate a hot compressed gaseous stream, each compressor being followed by intermediate cooler for removing thermal energy from the hot compressed gaseous stream. The system may also include a CO₂ cooled heat exchanger connected to receive and cool the hot compressed gaseous stream for delivery to a final compressor in the plurality of compressors, the CO₂ cooled heat exchanger being cooled by a CO₂ coolant stream generated within a downstream CO₂ separator. The final compressor may be configured to perform a further compression of the gaseous stream for delivery to a downstream recuperator.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1A is a block diagram of a gaseous input stream processing system in accordance with embodiments disclosed herein;

FIG. 1B is a block diagram of a CO₂ separator that may be implemented in the system shown in FIG. 1A;

FIG. 2 is a schematic view of an example of a hot compressor that may be implemented in the system shown in FIG. 1A;

FIG. 3A is a schematic view of an example of a hot compressor and energy storage disclosed herein;

FIG. 3B is a schematic view of an example of a hot compressor and energy storage disclosed herein;

FIG. 3C is a schematic view of an example of a hot compressor and steam plant disclosed herein;

FIG. 4 is a partially cut away perspective view of an example of a thermal energy store that may be implemented within the hot compressor of FIG. 3;

FIG. 5 is a schematic view of an example of an example of a thermal energy store disclosed herein;

FIG. 6 is a schematic view of an implementation of a cold compressor/recuperator that may be implemented in the system shown in FIG. 1A;

FIG. 7 is a perspective view of one implementation of the multi-stream heat exchanger shown in FIG. 6;

FIG. 8A is a schematic view of an example of a cold compressor/recuperator that may be implemented in the system shown in FIG. 1A;

FIG. 8B is a schematic view of an example of a cold compressor/recuperator that may be implemented in the system shown in FIG. 1A;

FIG. 9 is a schematic view of an example of a hot compressor, cold compressor, and recuperator disclosed herein;

FIG. 10A is a is a schematic view of an example of a CO₂ separator disclosed herein; and

FIG. 10B is a schematic view of an example of a shell and tube heat exchanger used to implement a heat exchanger of the CO₂ separator shown in FIG. 10A;

FIG. 11 is a is a schematic view of an example of a CO₂ separator disclosed herein;

FIG. 12A is a schematic view of an example of a CO₂ separator disclosed herein;

FIG. 12B is a schematic view of an example of a CO₂ separator disclosed herein;

FIG. 13 is a schematic view of an implementation of a CO₂ separator disclosed herein;

FIG. 14A is a schematic view of an example of a frost catcher that may be implemented in the CO₂ separator of FIG. 13;

FIG. 14B is a schematic view of an example of a frost catcher that may be implemented in the CO₂ separator of FIG. 13; and

FIG. 15 is a schematic view of a CO₂ separator disclosed herein.

### DETAILED DESCRIPTION

Gaseous CO₂ may be removed from a gaseous stream through the use of absorbents such as amines. Other methods for removal of gaseous CO₂ may involve cooling to cryogenic conditions where the gaseous CO₂ goes through a phase change to a solid, which may then be separated from the gaseous stream as either a liquid or solid. Commonly, cryogenic cooling is provided in the form of external cooling or refrigeration, which requires additional equipment. There remains a need for systems and techniques that may be implemented in for removing CO₂ from gaseous streams without the use of external refrigeration systems.

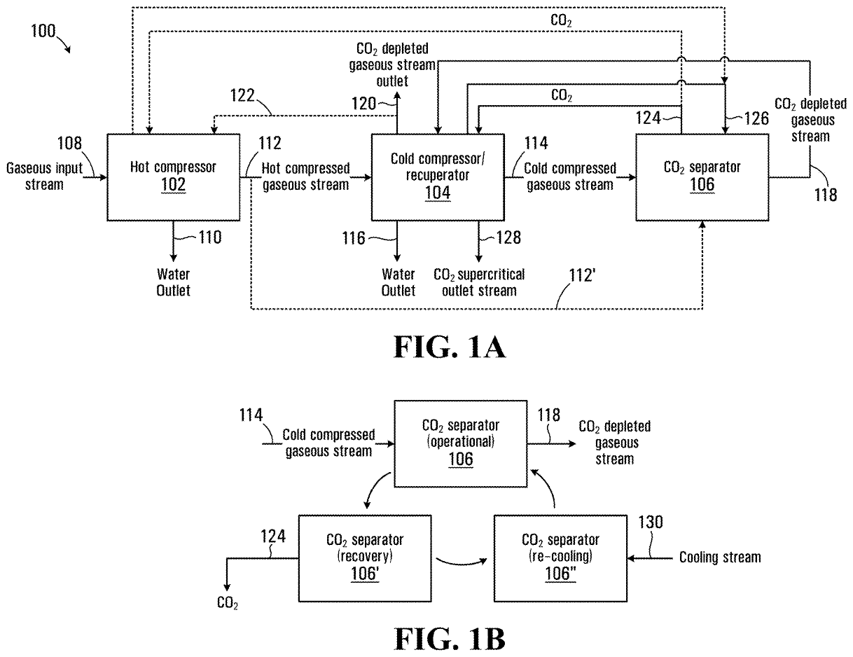

Referring to FIG. 1A, a gaseous input stream processing system is shown generally at 100. The system 100 includes a hot compressor 102, a cold compressor/recuperator 104, and a CO₂ separator 106. The hot compressor 102 receives a gaseous input stream 108 to be processed, which includes carbon dioxide (CO₂). The gaseous input stream 108 may be a flue gas generated in an upstream process such as a fossil fuel power plant, cement plant, steel plant, or any other industrial process that generates a flue gas having an increased proportion of CO₂ compared to ambient atmospheric air. As an example, in a coal power plant, the flue gas may have a CO₂ concentration of about 16%-21% by weight while a cement or steel plant flue gas may have a CO₂ concentration of about 20%-30% by weight. Other examples of industrial processes that generate significant CO₂ concentrations include pulp and paper processes, natural gas combined cycle (NGCC) processes, and natural gas boilers. The gaseous input stream 108 may be ambient atmospheric air, which generally has a CO₂ concentration of about 0.04%. The gaseous input stream 108 may be at around atmospheric pressure (i.e. about 1 bar). The temperature of the gaseous input stream 108 may vary depending on the nature of the upstream process that generates the stream.

The system 100 may be configured for the purpose of compressing and cooling the gaseous input stream 108 to a point where CO₂ can be separated out of the gaseous input stream 108. Alternatively or additionally the system 100 may be configured for additional or other purposes, such as temporary storage of thermal energy.

The hot compressor 102 performs a first compression of the gaseous input stream 108 to generate a hot compressed gaseous stream 112. In this context the term “hot” is used relative to downstream compressed gaseous streams, which would be at significantly lower temperatures than the hot compressed gaseous stream 112. The compression causes a substantial increase in the temperature of the gaseous input stream 108 and the hot compressor 102 will generally be configured to also cool the gaseous stream prior to discharge as the hot compressed gaseous stream 112. Cooling within the hot compressor 102 may have the additional function of causing water within the gaseous input stream 108 to condense, which may then be discharged via a water outlet 110. The hot compressed gaseous stream 112 may have a temperature of about 25 °C and a pressure of about 12 bar.

The hot compressed gaseous stream 112 is then processed through the cold compressor/recuperator 104 to generate a cold compressed gaseous stream 114, which may have a temperature of about −58 °C and a pressure of about 45 bar. Cooling of the hot compressed gaseous stream 112 may cause additional water within the gaseous input stream 108 to condense, which may then be discharged via a water outlet 116. The cold compressed gaseous stream 114 is then passed to the CO₂ separator 106 where the stream is further cooled to cause CO₂ within the stream to desublimate to form solid CO₂, which may appear as a frost within the CO₂ separator. Solidification of CO₂ facilitates separation of a substantial portion of CO₂ from the cold compressed gaseous stream 114 to generate a CO₂ depleted gaseous stream 118. The CO₂ depleted gaseous stream 118 may be regarded as a clean flue gas due to having a lowered concentration of CO₂.

The CO₂ depleted gaseous stream 118 may be fed back through the cold compressor/recuperator 104 in order to recuperate cooling from the stream. The CO₂ depleted gaseous stream 118 thus provides at least some of the cooling capacity for cooling the hot compressed gaseous stream 112 within the cold compressor/recuperator 104. Following recuperation of the cooling capacity of the CO₂ depleted gaseous stream 118 in the cold compressor/recuperator 104, the stream may be regarded as a clean flue gas and may be vented as a CO₂ depleted gaseous stream outlet 120. The clean flue gas may be vented to the atmosphere via a stack. In the system 100 shown in FIG. 1A, a portion 122 of the CO₂ depleted gaseous stream outlet 120 may be diverted back to the hot compressor 102, as described in further detail below.

Additional cooling within the cold compressor/recuperator 104 for generating the cold compressed gaseous stream 114 may be provided by a CO₂ coolant stream 124 from the CO₂ separator 106. Some of the CO₂ that is solidified and separated within the CO₂ separator 106 may be allowed to melt prior to being delivered to the cold compressor/recuperator 104 as a CO₂ coolant. The CO₂ coolant may be in a liquid or gaseous form that facilitates transport and delivery as a coolant to various other processes as described herein. The CO₂ coolant may then be returned as a return CO₂ stream 126 to the CO₂ separator 106 to be re-cooled. The CO₂ coolant may be further pressurized within the cold compressor/recuperator 104 to cause a phase transition into a supercritical CO₂ outlet stream 128 for storage or sequestration.

Optionally, a portion of the CO₂ coolant stream 124 may also be delivered to the hot compressor 102 for use in cooling of the hot compressed gaseous stream 112. In this case, after being used in the hot compressor 102, the CO₂ coolant is returned to the CO₂ separator 106 in the return CO₂ stream 126.

Referring to FIG. 1B, the CO₂ separator 106 may be initially operated in as described above in an operational mode where the CO₂ separator causes solidification of CO₂ from the cold compressed gaseous stream 114. Over time, solid CO₂ will accumulate to an extent where further operation may be impeded and the CO₂ separator 106 may be configured to change from the operational mode to a recovery mode (106′) in which the CO₂ separator 106 is warmed to cause solidified CO₂ to be melted and recovered as a CO₂ stream 124 further use in the system 100 or for sequestration. Once the solidified CO₂ has been removed from the CO₂ separator 106′ in the recovery mode, a coolant stream 130 may be delivered to the CO₂ separator 106″ in a re-cooling mode that re-cools the CO₂ separator prior to returning to the operational mode.

The CO₂ separator 106 may be implemented using two or more CO₂ separators that permit a periodic exchange between operational mode and the recovery mode. In this case, one of the CO₂ separators would be in the operational mode, while the other would be in either the recovery mode or the re-cooling mode.

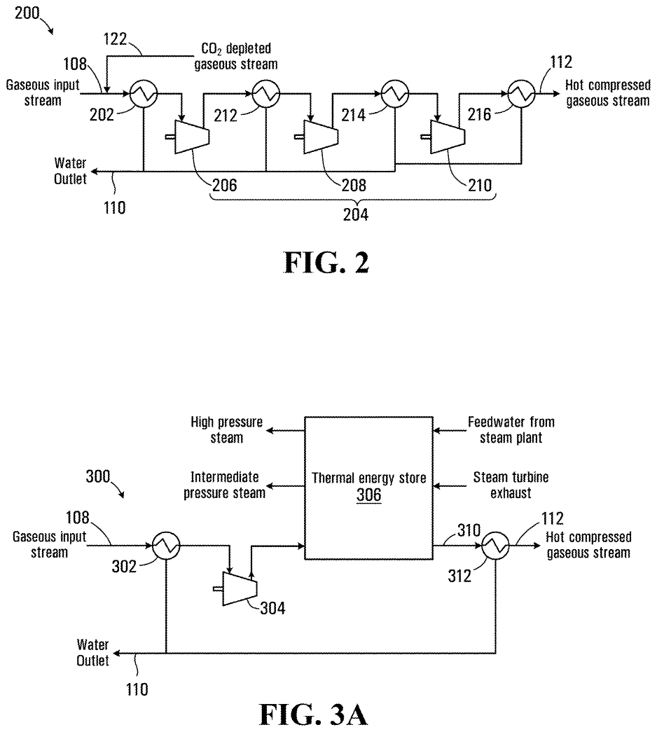

Referring to FIG. 2, an implementation of the hot compressor 102 is shown generally at 200. The hot compressor 200 includes a precooler heat exchanger 202 and a series of compressor stages 204. The precooler heat exchanger 202 receives and precools the gaseous input stream 108, which may cause condensation of water vapor within the heat exchanger 202. Condensed water is drained via the water outlet 110. The series of compressor stages 204 include a first compressor 206, a second compressor 208, and a third compressor 210. The series of compressor stages 204 include first, second and third intercoolers 212, 214, and 216 connected following each of the compressor stages. Each compressor stage 204 causes an increase in temperature of the gaseous stream and the first, second and third intercoolers 212, 214, and 216 re-cool the gaseous stream after compression. Condensation of water vapor within the intercoolers 212, 214, and 216 is drained via the water outlet 110.

The gaseous input stream 108 may be mixed with the portion 122 of the CO₂ depleted gaseous stream to generate a gaseous input stream having a CO₂ concentration that meets a target CO₂ concentration. The target CO₂ concentration may be associated with efficient operation of at least one of the downstream processing stages, such as a range of CO₂ concentration values for which the downstream processing has been determined to operate within a threshold efficiency.

Generally, the cold compressor/recuperator 104 and CO₂ separator 106 will be configured to operate efficiently when the gaseous input stream 108 falls within a range of CO₂ concentrations. For CO₂ concentrations outside this range, operation may be less efficient. The CO₂ depleted gaseous stream portion 122, when mixed with the gaseous input stream 108 dilutes the stream and lowers the overall CO₂ concentration to within the target CO₂ concentration range. As an example, the system 100 may have been configured to operate most efficiently on a coal power plant flue having a CO₂ concentration of about 16%-21% by weight. If the system 100 were to be deployed to process a flue from a cement or steel plant, the CO₂ depleted gaseous stream portion 122 may be used to lower the overall CO₂ concentration from typically 20%-30% by weight to fall within or closer to the configured 16%-21% by weight CO₂ concentration range. This has the advantage of facilitating use of the system 100 for processing a wider range of flue gas streams without substantial changes or reconfiguration.

The precooler heat exchanger 202 and the first, second and third intercoolers 212, 214, and 216 may be configured to use air as a cooling medium, which results in heat being extracted to the atmosphere. In FIG. 2, the series of compressor stages 204 includes three compression stages, however there may be a greater or lesser number of compression stages implemented.

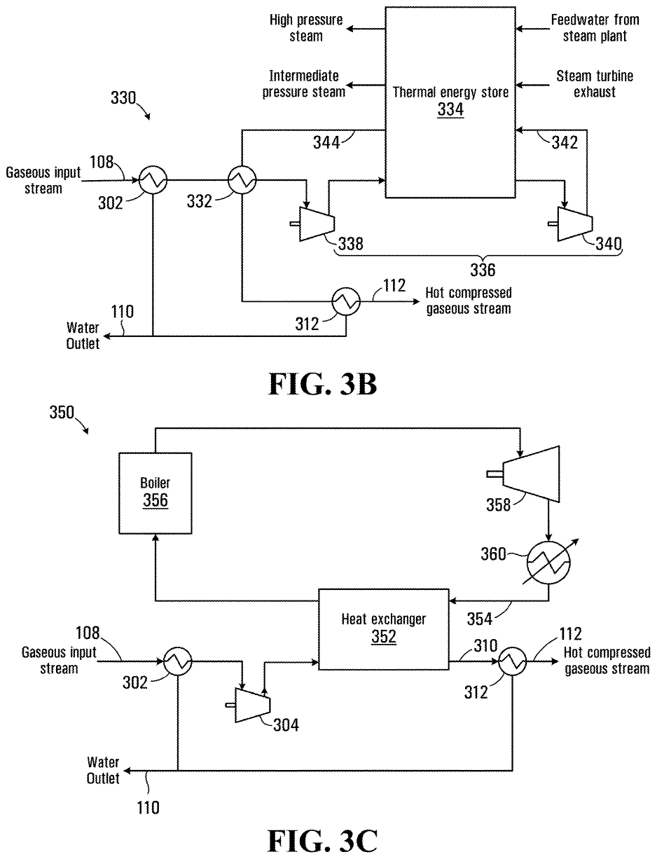

Referring to FIG. 3A, an implementation of the hot compressor 102 of the system 100 is shown generally at 300. The hot compressor 300 includes a precooler heat exchanger 302 that precools the gaseous input stream 108. The precooled stream discharged from the heat exchanger 302 may be near atmospheric pressure and at a temperature of about 27 °C. The hot compressor 300 also includes a compressor 304, which compresses the precooled stream. The stream discharged from the compressor 304 may be at a pressure of about 45 bar and have an increased temperature of about 600 °C. The hot compressor 300 also includes a thermal energy store 306, which is configured to channel the hot gaseous stream through a thermal energy storage medium while transferring thermal energy to the medium. The thermal energy storage medium may be any material that has a sufficient heat capacity to act as a temporary thermal energy store.

The thermal energy store 306 may function in place of the intercoolers 212-216 shown in FIG. 2 for extracting thermal energy from the compressed gaseous stream. However the thermal energy extracted from the hot compressed gaseous stream is not discharged into the atmosphere but is rather transferred to the thermal energy store 306. As such, thermal energy may be removed from the thermal energy store 306 and used for other purposes. As an example, the thermal energy store 306 may be configured to provide energy used in the generation of steam. The plant that generates the gaseous input stream 108 may include a steam generator that is configured to use thermal energy from the thermal energy store 306. The steam plant may include a steam turbine that operates on high pressure and high temperature steam. The thermal energy store 306 may receive a feedwater stream from a steam plant (not shown) and uses stored thermal energy within the thermal energy store to heat the feedwater stream to produce high pressure steam for driving the steam turbine. In an example where the stream discharged from the compressor 304 has a temperature of about 600 °C, the high pressure stream produced by the thermal energy store 306 may have a temperature of in the region of 600 °C.

Alternatively or in parallel, the thermal energy store 306 may receive the turbine exhaust stream from the steam turbine. This stream will typically have lower pressure and temperature than the high pressure steam stream. Thermal energy from the thermal energy store 306 may be used to upgrade the turbine exhaust stream to generate an intermediate pressure stream of steam which may be used to drive an intermediate pressure steam turbine. For example, where the thermal energy store 306 is heated to about 600 °C, the steam turbine exhaust may have a temperature of about 350 °C at a pressure of about 43 bar and the generated intermediate pressure stream may be raised to a temperature of in the region of 560 °C-600 °C after passing through the thermal energy store 306.

The hot compressor 300 may also include an aftercooler heat exchanger 312 that further cools the gaseous stream 310 discharged from the thermal energy store 306 to provide the hot compressed gaseous stream 112 for delivery to the cold compressor/recuperator 104 of the system 100 of FIG. 1A. The hot compressed gaseous stream 112 may be discharged from the aftercooler heat exchanger 312 at a temperature of about 27 °C. The aftercooler heat exchanger 312 is also configured to drain any condensed water vapor to the water outlet 110.

The compressor 304 may only be capable of heating the thermal energy store 306 to a temperature that is insufficient to generate high pressure steam or even intermediate pressure steam. In this case the thermal energy within thermal energy store 306 may be used for other heating purposes, such as pre-heating the feedwater stream used in the steam plant.

Referring back to FIG. 1A, when operating of the system 100 for recovering CO₂, the gaseous stream 112 is delivered to the cold compressor/recuperator 104 and then ultimately to the CO₂ separator 106, where CO₂ separation is performed as disclosed in more detail later herein. However, in some cases, it may be desirable to discontinue recovery of CO₂ in the CO₂ separator 106. In this case the gaseous stream 310 may be diverted before the aftercooler heat exchanger 312 and rather delivered as a stream 112′ directly to the CO₂ separator 106 for recovery of the remaining thermal energy within the stream. For example, the CO₂ separator 106 may include one or more expanders through which the hot compressed gaseous stream 112 may be expanded to convert thermal energy into mechanical work. The mechanical work may be employed to generate electrical energy, for example.

Referring to FIG. 3B, a hot compressor is shown generally at 330. The hot compressor 330 includes some elements in common with the FIG. 3 hot compressor such as the precooler heat exchanger 302 for precooling the gaseous input stream 108 and the aftercooler heat exchanger 312 for providing the hot compressed gaseous stream 112 for delivery to the cold compressor/recuperator 104. The precooler heat exchanger 302 is included primarily to extract water vapor from the gaseous input stream 108, which is discharged from the hot compressor 330 via the water outlet 110. The hot compressor 330 may further include a preheater heat exchanger 332, a thermal energy store 334, and a pair of compression stages 336. The pair of compression stages 336 include a first compressor 338 and a second compressor 340.

The first compressor 338 is connected to receive the stream discharged from the preheater heat exchanger 332 and to deliver a compressed stream to the thermal energy store 334. The precooler heat exchanger 302 cools the gaseous input stream 108 to about 27 °C and the preheater re-heats the stream to about 150 °C. The first compressor 338 compresses the stream and heats the stream to about 475 °C for delivery to the thermal energy store 334. Following extraction of thermal energy by the thermal energy store 334, the stream is discharged at a temperature of about 350 °C and passed through the second compressor 340. The second compressor 340 further compresses and heats the stream and then returns the stream through the thermal energy store 334 as a steam 342. The stream 342 may be at a temperature of about 600 °C. The thermal energy store 334 extracts and stores additional thermal energy from the stream 342, which is discharged from the thermal energy store 334 as a stream 344.

The pressure of the stream 344 discharged from the thermal energy store 334 may remain at about 23 bar and the stream will typically still have an elevated temperature (about 160 °C, for example). The stream 344 may be used to heat the preheater heat exchanger 332 prior to being discharged via the aftercooler heat exchanger 312. The preheater heat exchanger 332 uses the thermal energy from the stream 344 to preheat the gaseous input stream 108 prior to compression by the first compressor 338 as described above. The aftercooler heat exchanger 312 further cools the gaseous stream to provide the hot compressed gaseous stream 112. This arrangement has the advantage of making use of remaining thermal energy in the stream 344 that is discharged from the thermal energy store 334, which would be otherwise removed within the aftercooler heat exchanger 312. The hot compressed gaseous stream 112 may be discharged from the aftercooler heat exchanger 312 at a temperature of about 27 °C.

The thermal energy store 334 may be similarly configured to the thermal energy store 306 shown in FIG. 3A except for the additional steam 342 passing through the thermal energy store. As in the example above, the thermal energy store 334 may be configured to provide energy used in the generation of steam by receiving a feedwater stream and/or a turbine exhaust stream from a steam turbine and generating high pressure and/or intermediate pressure steam.

An alternative implementation to that shown in FIG. 3B is shown in FIG. 3C at 350. Referring to FIG. 3C, in this implementation, the thermal energy store 306 is replaced with a steady state heat exchanger 352. The steady state heat exchanger 352 is optimized to transfer the thermal energy to a stream such as a feedwater stream 354 passing through the heat exchanger. In contrast, the thermal energy store 306 may be optimized to include additional heat capacity to store energy for some period of time. The steady state heat exchanger 352 heats the feedwater 354 and delivers the feedwater to a boiler 356, which generates steam for driving a steam turbine 358. A condenser 360 condenses steam to generate the feedwater stream 354, which is recirculated through the steady state heat exchanger 352.

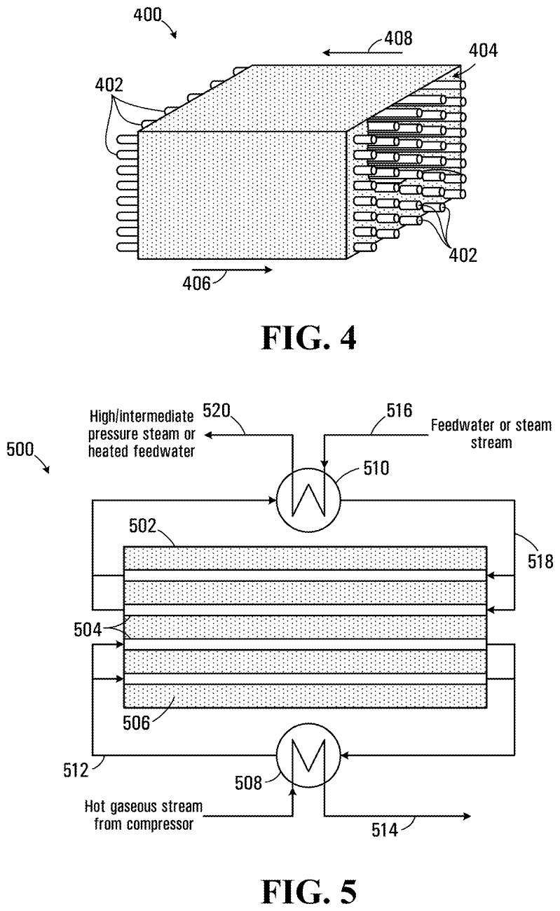

Referring to FIG. 4, an example of the thermal energy store 306 is shown generally at 400. The thermal energy store 400 includes a plurality of conduits 402 that extend through a medium 404 that provides heat capacity for storage of energy. Thermal energy may be transferred between a fluid flowing through any of the plurality of conduits 402 to the medium 404. Alternatively, thermal energy may be transferred from the medium 404 to a fluid flowing through any of the plurality of conduits 402. The medium 404 may be a material such as concrete that provides a sensible heat capacity for storage of energy. The conduits 402 may be implemented using thermally conductive tubing, such as steel, embedded within the concrete or other medium 404. In this case thermal energy is transferred between the fluids and the medium 404 via the thermally conductive tubing. The conduits 402 may be formed directly within the concrete or other medium 404 as tubular channels and the thermal energy transfer would then be directly between the fluids and medium 404.

The medium 404 is shown partially cut-away in FIG. 4 to reveal portions of some of the plurality of conduits 402 extending through the medium. The plurality of conduits 402 may be provided by embedding tubes (for example steel tubes) within the medium 404 such that the walls of the tubes are in thermal contact with the medium. Alternatively, the conduits may be formed as open channels extending through the medium where the walls of the channels are provided by the material. Alternatively, the medium 404 may be a phase change medium through which the plurality of conduits 402 extend, where the phase change medium provides a latent heat capacity for storage of energy.

The conduits 402 shown in FIG. 4 may be connected to implement the stream flows shown generally for the thermal energy stores 306 and 334 of FIGS. 3A and 3B respectively. For example, a subset of the plurality of conduits 402 may be connected in parallel to carry the hot compressed gaseous stream or streams discharged from the compressors 304, 338 and 340 for transferring thermal energy to the medium 404. The subset of the connected tubes 421 may also be distributed across the medium 404 so that the thermal energy transfer to the medium from the hot compressed gaseous streams is more homogenous. Other subsets of the plurality of conduits 402 may be connected to receive the feedwater or steam turbine exhaust streams and to channel these flows through the medium 404 for receiving thermal energy from the medium 404. For improved thermal energy transfer, the hot compressed gaseous streams may be connected to flow in a first direction 406 through the medium 404 while the feedwater and/or steam turbine exhaust streams may be connected to flow in a second counterflow direction 408 through the medium 404.

In the above embodiments the thermal energy stored within the thermal energy stores 306 or 334 is described in reference to generation of steam, in other embodiments the thermal energy may be used in other industrial processes.

The gaseous input stream 108 may be continuously generated as a by-product of an industrial process, in which case the thermal energy stores 306 and 334 may concurrently receive a transfer of thermal energy from the hot compressed gaseous stream while delivering thermal energy to the feedwater or steam streams. Alternatively or additionally the industrial process may be intermittently taken offline, in which case the gaseous input stream 108 may not be available for a period of time. Thermal energy delivery to the thermal energy stores 306 or 334 from the hot compressed gaseous stream may thus be intermittent. The thermal energy stores 306 or 334 may have sufficient heat capacity to maintain operation, such as the generation of steam or heating of feedwater, while the gaseous input stream 108 is offline.

The system 100 may be alternatively or additionally configured to be capable of operating on an ambient air gaseous input stream 108. In this case, the compressors 304, 338 and 340 of FIG. 3A and FIG. 3B may continue to operate on the ambient air gaseous input stream 108, resulting in ongoing storage of thermal energy in the thermal energy store 306 or 334. Alternatively, the system 100 may be configured for operation on an ambient air gaseous input stream in the absence of the availability of a nearby process that generates a flue gas input stream for the system. As disclosed above, the CO₂ concentration within ambient air is considerably less than in a typical flue gas. However for the purpose of the hot compressors 300 and 330 shown in FIG. 3A and FIG. 3B, the compression of the gaseous input stream results in significant generation of thermal energy that may still be stored within the thermal energy stores 306 or 334.

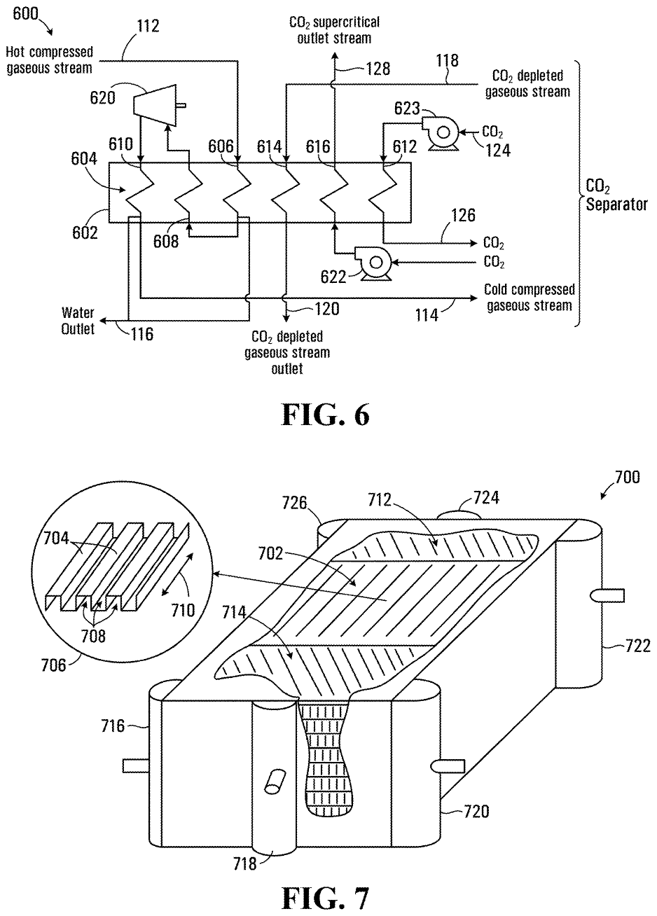

The embodiments described above with reference to FIG. 3A and FIG. 3B are configured for a direct transfer of thermal energy from the hot compressed gaseous stream to the thermal energy stores 306 or 334 and from the thermal energy stores to the feedwater or stream streams. An alternative example is shown schematically in FIG. 5 at 500 and includes a thermal energy store 502 having a plurality of conduits 504 extending through a medium 506. The conduits 504 may be directly formed within the medium 506 or may be implemented as thermally conductive tubes embedded within the medium. Only four conduits 504 are shown in FIG. 5, however it should be understood that the thermal energy store 502 may include a larger number of conduits.

The system 500 also includes a first heat exchanger 508 and a second heat exchanger 510. The first heat exchanger 508 is connected to receive the hot gaseous stream from the compressors of FIG. 3A and FIG. 3B and to transfer thermal energy from the hot stream to a heat transfer fluid 512. The heat transfer fluid 512 may be air or any other heat transfer fluid. The heat transfer fluid 512 is delivered to a pair of the conduits 504 for transferring thermal energy to the medium 506. Thermal energy is therefore indirectly transferred to the thermal energy store 502. The heat transfer fluid 512 is circulated back to the first heat exchanger 508, where it is heated by the hot gaseous stream passing through the first heat exchanger 508. The hot gaseous stream is returned from the first heat exchanger 508 as a stream 514 that is fed to the aftercooler heat exchanger 312 of FIG. 3A or the second compressor 340 or preheater heat exchanger 332 of FIG. 3B.

The second heat exchanger 510 is connected to receive a feedwater or steam stream 516, generally as described above. The second heat exchanger 510 is connected to circulate a heat transfer fluid 518 through another pair of the plurality of conduits 504. The heat transfer fluid 518 may be air or any other heat transfer fluid. Thermal energy from the medium 506 is transferred to the heat transfer fluid 518, which in turn transfers the thermal energy to the feedwater or steam stream 516 passing through the second heat exchanger 510. Depending on the temperature of the medium 506, the stream 516 is discharged as a stream 520 comprising heated feedwater, or intermediate or high pressure steam.

Alternatively a hybrid between direct and indirect transfer may be implemented where one of the first heat exchanger 508 or second heat exchanger 510 are eliminated in favor of a direct transfer.

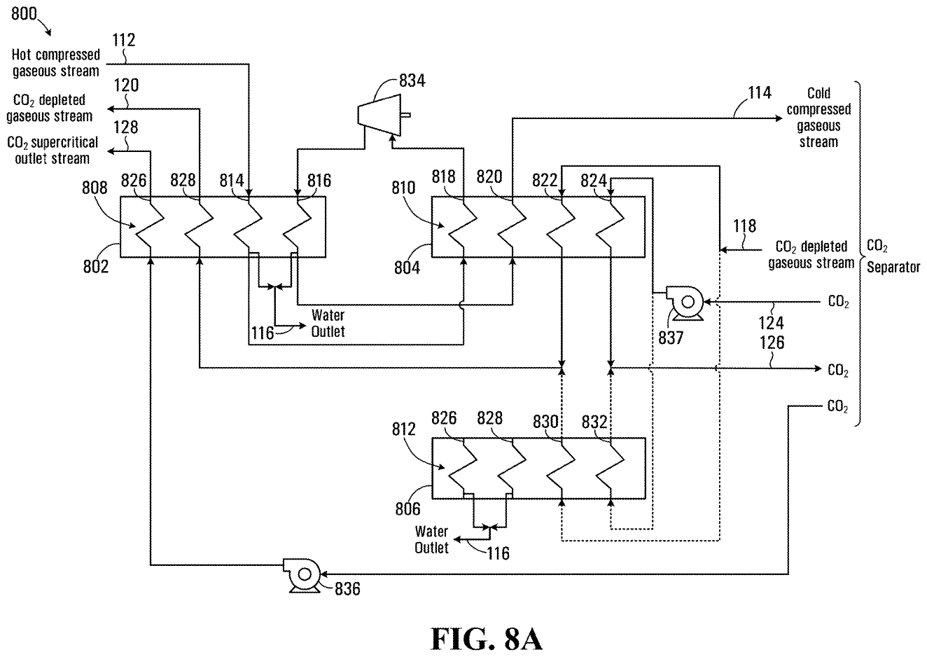

Referring back to FIG. 1A, the hot compressed gaseous stream 112 may have a temperature of around 25 °C and a pressure of about 12 bar. The stream may be further cooled and compressed in the cold compressor/recuperator 104 before being delivered to the CO₂ separator 106 for extraction of CO₂. Referring to FIG. 6, an implementation of the cold compressor/recuperator 104 is shown generally at 600. The cold compressor/recuperator 600 may be implemented using a multi-stream heat exchanger 602. The multi-stream heat exchanger 602 includes a plurality of fluid flow passages 604, each passage being in thermal communication with at least one other passage in the plurality of passages. As such, each fluid flow passage 604 acts as a heat exchanger passage within the multi-stream heat exchanger 602.

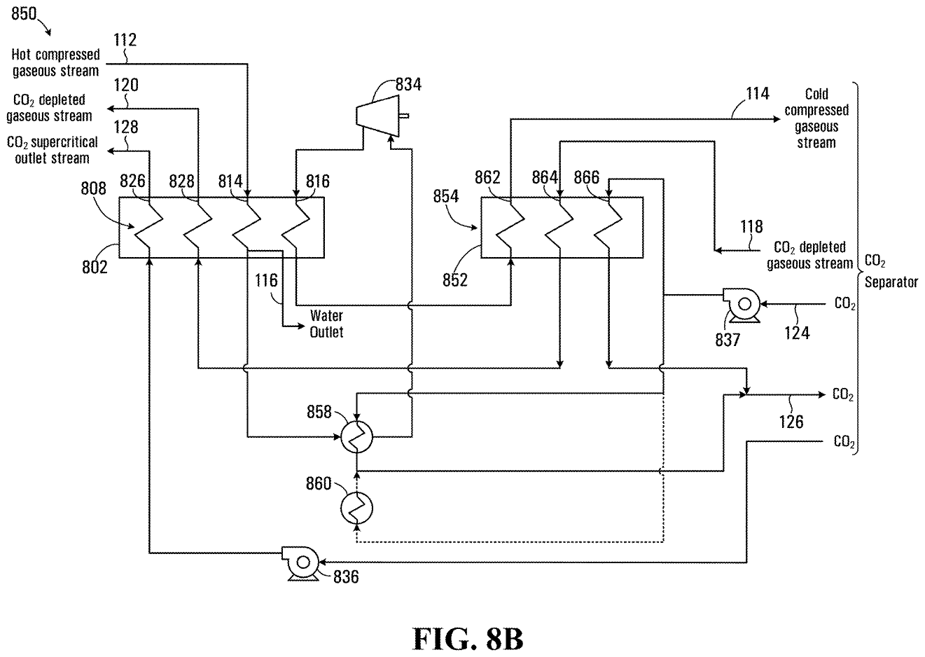

An example of a multi-stream heat exchanger is shown in FIG. 7 at 700. The heat exchanger 700 includes a heat transfer area 702, which is shown in a partly cut-away view. The heat transfer area 702 may be constructed from corrugated sheets 704, an example of which is shown in an insert 706. The corrugated sheets 704 define a plurality of adjacent fluid flow passages 708 in directions indicated by the arrow 710. Each passage 708 is in thermal communication with at least one adjacent passage in the plurality of fluid flow passages 708. The heat exchanger 700 further includes distribution areas 712 and 714 and headers 716, 718, 720, 722, 726 and 726 each having a respective inlet nozzle for receiving or discharging a fluid flow. The headers 716-726 channel the fluid flows via the heat exchanger 700 further includes distribution areas 712 and 714 to the fluid flow passages 708 in the heat transfer area 702 where the primary heat transfer takes place. Some of the passages 708 may carry a hot fluid stream while others carry a colder fluid stream, which facilitates heat transfer between the respective streams for providing cooling within the multi-stream heat exchanger. In contrast to a conventional heat exchanger, the multi-stream heat exchanger 700 facilitates thermal energy transfer between more than just two fluid streams.

Referring back to FIG. 6, an inlet passage 606 is connected to receive the hot compressed gaseous stream 112, which is cooled while passing through the inlet passage. The hot compressed gaseous stream 112 may still include water vapor that would condense within the inlet passage 606 and may be drained to the water outlet 116 (shown in FIG. 1A). The inlet passage 606 is connected to channel the stream through an additional passage 608 to provide further cooling of the hot compressed gaseous stream 112.

The cold compressor/recuperator 600 also includes a compressor 620 connected to receive the hot compressed gaseous stream that has been cooled within the inlet passage 606 and passage 608. The compressor 620 is configured to compress the stream and to discharge the compressed gaseous stream via an outlet passage 610. The stream entering the compressor 620 may have a temperature of about −43 °C at a pressure of 12 bar and the compression increases the temperature of the stream to about 84 °C with a pressure of about 45 bar. The compressed stream is then cooled within the outlet passage 610 to a temperature of about −58 °C prior to being returned to the CO₂ separator 106. Any water vapor that condenses within the outlet passage 610 is channeled to the water outlet 116.

The multi-stream heat exchanger 602 may be cooled by two streams that originate within the CO₂ separator 106. The CO₂ coolant stream 124 is received from the CO₂ separator 106 and channeled via a pump 623 through the passage 612. Generation of the CO₂ coolant stream 124 in the CO₂ separator 106 CO₂ is described later herein. The CO₂ coolant stream 124 may have a temperature of about −46 C at a pressure of about 12 bar. CO₂ coolant is returned to the CO₂ separator 106 from the passage 606 as the return CO₂ stream 126. A CO₂ depleted gaseous stream may also be received from the CO₂ separator 106 and channeled through a passage 614 to provide recuperative cooling of the multi-stream heat exchanger 602. The CO₂ depleted gaseous stream may have a temperature of about −68 °C and a pressure of about 1 bar.

The coolant flows provided by the CO₂ coolant stream 124 and CO₂ depleted gaseous stream thus provide the cooling for the hot gaseous stream flowing through the outlet passage 610 and passage 612 and the CO₂ depleted gaseous stream 118 being discharged via the passage 614. The CO₂ depleted gaseous stream may be discharged from the passage 614 after recuperating cooling from the stream will have a temperature of about 57 °C and a pressure around atmospheric pressure and may be vented as the clean CO₂ depleted gaseous outlet stream 120.

As disclosed above, the CO₂ coolant stream 126 is returned to the CO₂ separator 106. The cold compressor/recuperator 600 may further include a supercritical pressurizer 622 connected to receive CO₂ from the CO₂ separator 106. The supercritical pressurizer 622 further pressurizes the CO₂ coolant to a pressure of about 100 bar, which is above the critical point of CO₂. The supercritical pressurizer 622 is connected to deliver the supercritical stream through the passage 616 to produce the supercritical CO₂ outlet stream 128. Converting the CO₂ coolant into supercritical CO₂ has advantages in connection with transport and sequestering of the CO₂.

In FIG. 6, the passages 612, 614, and 616 will carry colder fluid flows than the passages 606, 608, and 610. For illustrational convenience in FIG. 6, the colder passages 612, 614, and 616 are shown on the right hand side of the multi-stream heat exchanger 602 and the hotter passages 606, 608, and 610 are shown on the left hand side. However, in practice, the fluid flow passages 604 will typically be arranged such that each of the colder passages is disposed alongside one of the hotter passages to optimize thermal exchange between the fluids flowing through the various passages.

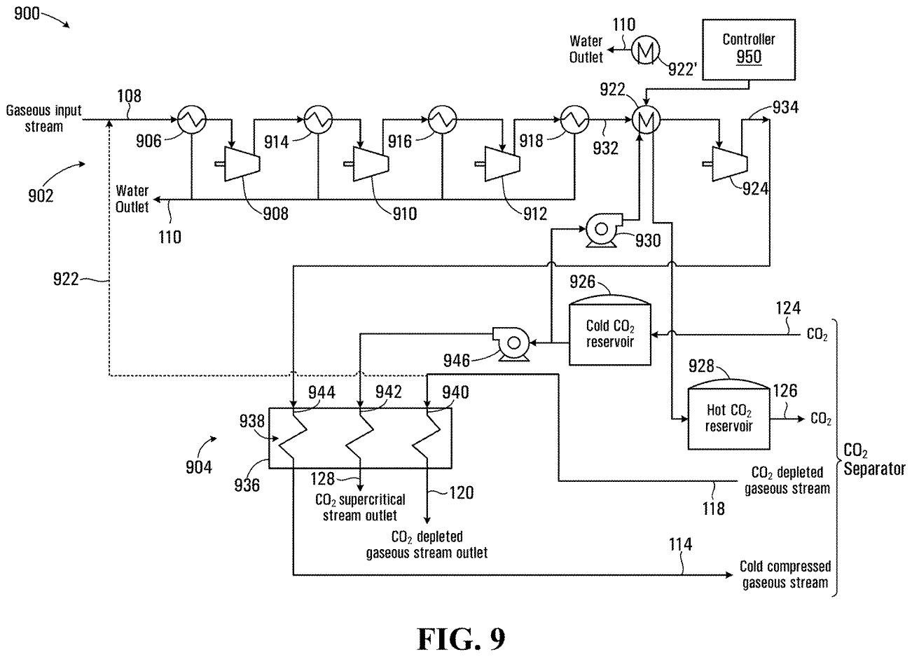

Referring to FIG. 8A, an implementation of the cold compressor/recuperator 104 is shown generally at 800. The cold compressor/recuperator 800 includes an above freezing multi-stream heat exchanger 802 having a plurality of fluid flow passages 808. The cold compressor/recuperator 800 also includes an operational below freezing multi-stream heat exchanger 804 and a recovery multi-stream heat exchanger 806, each having a respective plurality of fluid flow passages 810 and 812. The terms “above freezing” and “below freezing” as used above should be understood to be in reference to the freezing point of water. Within each of the heat exchangers 802, 804, and 806, the respective passages 808, 810, and 810 are in thermal communication with at least one other passage. The multi-stream heat exchangers 802, 804, and 806 may be implemented generally as shown in FIG. 7.

The below freezing multi-stream heat exchanger 804 receives the two coolant streams from the CO₂ separator 106, namely the CO₂ coolant stream 124 and CO₂ depleted gaseous stream 118 as described above in connection with FIG. 6. The CO₂ coolant stream 124 is delivered via a pump 837 and the streams 118 and 124 are respectively connected through the passages 822 and 824 and provide recuperative cooling of the heat exchanger 804. These relatively cold coolant streams will generally cool other streams flowing through the passages 818 and 820 in the heat exchanger 804 to a temperature below the water freezing point of 0 °C.

The CO₂ coolant stream that is discharged from the passage 824 of the below freezing heat exchanger 804 is returned to the CO₂ separator 106 as the return CO₂ stream 126. Another CO₂ stream received from the CO₂ separator 106 is pressurized to a supercritical pressure and temperature by a supercritical pressurizer 836 and connected through the passage 826 to provide cooling of the above freezing exchanger 802. Further cooling for the above freezing heat exchanger 802 is provided by the CO₂ depleted gaseous stream discharged from the below freezing heat exchanger 804. These streams will have been warmed by passing through the below freezing heat exchanger 804 but are still cold enough to provide cooling for the above freezing multi-stream heat exchanger 802. The above freezing heat exchanger 802 is thus cooled to a lesser extent than the below freezing heat exchanger 804 due to the relatively warmer coolant streams. The supercritical CO₂ stream is discharged from the passage 826 of the heat exchanger 802 as the supercritical CO₂ outlet stream 128 and the CO₂ depleted gaseous stream is discharged as the CO₂ depleted gaseous stream outlet 120.

The hot compressed gaseous stream 112 from the hot compressor 102 is received at an inlet passage 814 of the above freezing heat exchanger 802 and is connected through to a passage 818 of the operational below freezing multi-stream heat exchanger 804. The hot compressed gaseous stream 112 is thus cooled within the passage 814 by the coolant streams channeled through passages 826 and 828. The heat exchanger 804 precools the stream while passing through the passage 818 before being delivered to a compressor 834. The compressor 834 compresses and warms the stream, which is delivered back to a passage 816 of the above freezing heat exchanger 802. The streams passing though the passages 814 and 816 are relatively hot and are cooled by the coolant streams in the passages 826 and 828 before being delivered to the below freezing heat exchanger 804. The stream compressed and warmed by the compressor 834 is precooled in the passage 816 and then delivered to the passage 820 of the above freezing heat exchanger 802, where the stream is substantially cooled before being delivered to the CO₂ separator 106 for extraction of CO₂ by freezing.

Any water that condenses within the passages 814 and 816 is drained via the water outlet 116. Advantageously, since the multi-stream heat exchanger 802 remains above the freezing point of water, condensed water vapor will not freeze within the passages 814 and 816, which could potentially cause a blockage within the heat exchanger.

Within the operational heat exchanger 804, substantial cooling is provided by the coolant streams 124 and 118 received from the CO₂ separator 106. These coolant streams may cause condensed water vapor to freeze within the passages 818 and 820, which could potentially lead to these passages becoming partly or completely blocked over time. The recovery multi-stream heat exchanger 806 may be essentially a duplicate of the below freezing multi-stream heat exchanger 804, both of which are configured to be disconnected from time to time to permit frozen water to be melted and drained to the water outlet 116.

In FIG. 8A, the operational below freezing multi-stream heat exchanger 804 is shown connected to receive the hot compressed gaseous stream at the passage 818 and the compressed gaseous stream at the passage 820. The recovery multi-stream heat exchanger 806 will have been disconnected to facilitate defrosting of the passages 826 and 828. Initially all of the passages 826-832 of the recovery heat exchanger 806 would be disconnected from receiving the hot compressed gaseous stream and the cold compressed gaseous stream from the above freezing multi-stream heat exchanger 802 and the coolant streams from the CO₂ separator 106. This allows the heat exchanger 806 to warm up within the ambient environment.

At some point in time, when the water within the passages has substantially melted and been drained to the water outlet 116, the recovery multi-stream heat exchanger 806 may be re-cooled to a temperature below freezing before being reconnected to receive the hot compressed gaseous stream and the cold compressed gaseous stream from the above freezing multi-stream heat exchanger 802. The re-cooling may involve diverting a portion of the cold CO₂ depleted gaseous stream from the CO₂ separator 106 through the passage 830 of the recovery multi-stream heat exchanger 806. Similarly a portion of the CO₂ coolant stream from the CO₂ separator 106 may be diverted through the passage 832 of the recovery multi-stream heat exchanger 806. The cooling provided by these cold streams cause the recovery multi-stream heat exchanger 806 to be re-cooled to a temperature below freezing prior to the re-connecting the heat exchanger to receive the hot gaseous streams from the above freezing multi-stream heat exchanger 802. When the recovery multi-stream heat exchanger 806 reaches standard operating temperature, the below freezing multi-stream heat exchanger 804 may be disconnected and the recovery multi-stream heat exchanger 806 reconnected to receive the hot compressed gaseous stream and the cold compressed gaseous stream from the above freezing multi-stream heat exchanger 802.

One advantage of the configuration shown in FIG. 8A is that water in the hot compressed gaseous stream does not freeze within the passages of the above freezing multi-stream heat exchanger 802, which facilitates continuous operation of this heat exchanger. Only the below freezing multi-stream heat exchanger 804 and recovery multi-stream heat exchanger 806 are subject to freezing of water within passages.

Referring to FIG. 8B, an alternative implementation of the cold compressor/recuperator 104 of FIG. 1A is shown generally at 850. The above freezing multi-stream heat exchanger 802 from FIG. 8A appears implemented substantially as described above. The cold compressor/recuperator 850 also includes a below freezing multi-stream heat exchanger 852 having a plurality of fluid flow passages 854. Within each of the heat exchangers 802 and 852, the respective passages 808 and 854 are in thermal communication with at least one other passage in each heat exchanger.

In this example, one of the fluid flow passages implemented in the FIG. 8A below freezing multi-stream heat exchanger is implemented as a separated heat exchanger 858 having a conventional heat exchanger configuration. For example, the separated heat exchanger 858 may be implemented as a conventional shell and tube heat exchanger. The hot compressed gaseous stream 112 from the hot compressor 102 is received at the inlet passage 814 of the above freezing heat exchanger 802 and is connected through the separated heat exchanger 858. The separated heat exchanger 858 is cooled by the CO₂ coolant stream 124, which will cause water in the stream to freeze within the heat exchanger before being delivered to the compressor 834.

The separation of the passage from the below freezing multi-stream heat exchanger 852 into the separated heat exchanger 858 has the advantage of preventing frozen water accumulation in the below freezing multi-stream heat exchanger. This reduces or completely eliminates the need to take the heat exchanger 852 out of operation to remove accumulated frozen water by defrosting. Rather only the separated heat exchanger 858 need be taken out of operation from time to time for removal of frozen water accumulation. The cold compressor/recuperator 850 includes a recovery separated heat exchanger 860 that may be interchanged with the operational separated heat exchanger 858 after there has been a significant accumulation of frozen water.

The recovery heat exchanger 860 may be disconnected from the CO₂ coolant stream 124 during transitioning to permit warming, which causes the accumulated frozen water to melt thus facilitating removal as a liquid. Once the frozen water accumulation has been removed, the recovery separated heat exchanger 860 may be connected to receive the CO₂ coolant stream 124 for re-cooling the heat exchanger before returning it to operation.

Other than the incorporation of the separated heat exchanger 858 and recovery heat exchanger 860, operation of the cold compressor/recuperator 850 is generally as described above in connection with the FIG. 8A. The below freezing multi-stream heat exchanger 852 receives two coolant streams from the CO₂ separator 106, namely the CO₂ coolant stream 124 and CO₂ depleted gaseous stream 118 as described above in connection with FIG. 6. The CO₂ coolant stream 124 is delivered via a pump 837 and the coolant streams 118 and 124 are respectively connected through passages 866 and 864 and provide recuperative cooling of the heat exchanger 852. These relatively cold coolant streams will generally cool the stream flowing through the passage 862 in the heat exchanger 852 to a temperature below the water freezing point of 0 °C. However, since a significant proportion of water in the gaseous stream has already been removed in the separated heat exchanger 858, there should be little or no accumulation of frozen water within the passage 862.

The CO₂ coolant stream that is discharged from the passage 866 of the heat exchanger 852 is returned to the CO₂ separator 106 as the return CO₂ stream 126. Another CO₂ stream received from the CO₂ separator 106 is pressurized to a supercritical pressure and temperature by a supercritical pressurizer 836 and connected through the passage 826 to provide cooling of the above freezing exchanger 802.

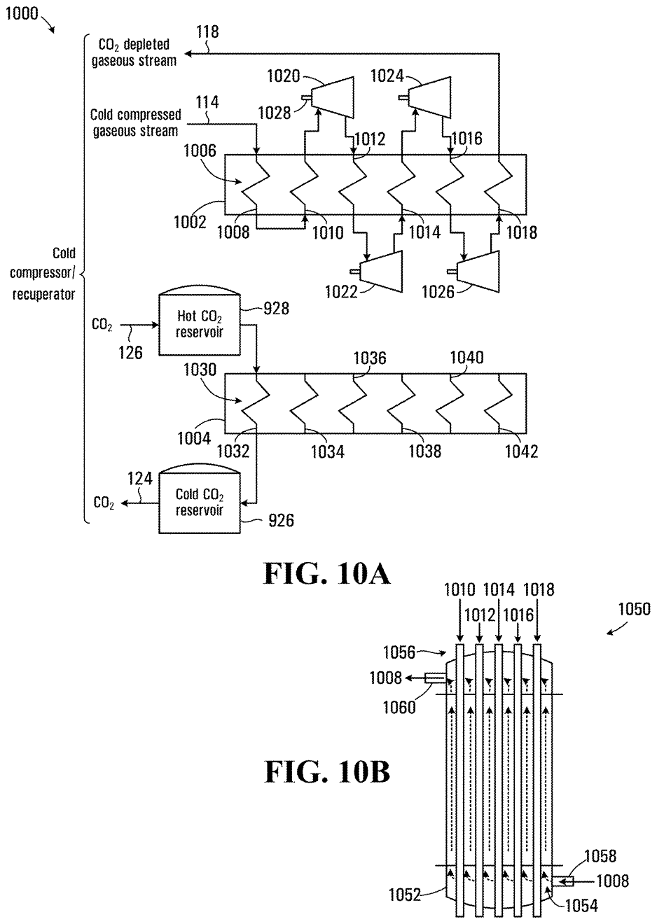

Referring to FIG. 9, an alternative configuration of the hot compressor 102 and cold compressor/recuperator 104 is shown generally at 900. The apparatus 900 includes a hot compressor 902 and a downstream recuperator 904. The hot compressor 902 includes a precooler heat exchanger 906, a series of compressor stages, and intercoolers between the compressor stages generally as described above in connection with FIG. 2. The precooler heat exchanger 906 receives and precools the gaseous input stream 108, which may cause condensation of water vapor within the heat exchanger and facilitates removal of some water vapor as condensed water via the water outlet 110.

The series of compressor stages include a first compressor 908, a second compressor 910 and a third compressor 912. A first intercooler 914, a second intercooler 916, and a third intercooler 918 are connected following each of the compressor stages. Each compressor stage 908, 910 and 912 causes an increase in temperature of the gaseous stream and the first, second and third intercoolers 914, 916, and 918 re-cool the gaseous stream after compression. Condensation of water vapor within the intercoolers 914, 916, and 918 is drained via the water outlet 110.

This example differs from the FIG. 2 example in that a CO₂ cooler 922 is connected between the third intercooler 918 and an additional fourth compressor 924. The CO₂ cooler 922 is cooled by the CO₂ coolant stream 124 generated in the CO₂ separator 106. Cold CO₂ is accumulated in a cold CO₂ reservoir 926 and this CO₂ coolant is pumped through the CO₂ cooler 922 by a circulation pump 930. CO₂ coolant is returned to a hot CO₂ reservoir 928, a portion of which is delivered back to the CO₂ separator 106 as the CO₂ coolant stream 126 for re-cooling the CO₂ separator 106. In this context the terms “hot” and “cold” are used in a relative sense, in that the hot CO₂ reservoir 928 contains CO₂ at a higher temperature than the cold CO₂ reservoir 926. Alternatively, the hot CO₂ reservoir 928 may be omitted and the return CO₂ stream 126 may be returned directly to the CO₂ separator 106 rather than first passing through a hot CO₂ reservoir.

The CO₂ cooler 922 is selectively operated to facilitate control of the CO₂ coolant temperatures within the cold CO₂ reservoir 926 and hot CO₂ reservoir 928. For example, if the CO₂ temperature in the cold CO₂ reservoir 926 is too low, the CO₂ cooler 922 may be brought into operation to remove thermal energy from the gaseous input stream 108 thus causing warming of the CO₂ in the cold CO₂ reservoir. When the cold CO₂ reservoir 926 and the hot CO₂ reservoir 928 have CO₂ temperatures within a desired range, cooling of the CO₂ cooler 922 by CO₂ may be discontinued.

A controller 950 may be configured to selectively cause CO₂ coolant to be delivered to the CO₂ cooled heat exchanger 922 when either electricity costs and/or electricity demand is higher than a threshold. The controller may further be configured to selectively discontinue delivery of CO₂ coolant to the CO₂ cooled heat exchanger 922 when wither electricity costs and/or demand are lower than the threshold. The controller thus provides an additional benefit of being able to improve system performance by introducing additional CO₂ cooling when electricity rates are low or demand for electricity is low. Additionally, when electricity rates and/or demand are higher, usage of electricity may be reduced at the expense of slightly lower system efficiency.

A stream 932 that is discharged from the intercooler 918 is essentially similar to the hot compressed gaseous stream 112 as mentioned above in that the stream has been compressed but is still considered a “hot” stream since it will not yet be at a temperature where water will freeze within the heat exchanger. The hot compressed gaseous stream 932 is then further cooled in the CO₂ cooler 922 to a lower temperature, which may cause water within the gaseous input stream 108 to be frozen within the heat exchanger. The CO₂ cooler 922 may be implemented as a pair of cycling heat exchangers including the operational CO₂ cooler 922 and a recovery CO₂ cooler 922′. While the CO₂ cooler 922 is in operation, the recovery CO₂ cooler 922′ is disconnected from receiving the CO₂ coolant to cause frozen water within the passages to be melted to facilitate removal via the water outlet 110.

The gaseous stream discharged from the CO₂ cooler 922 is delivered to the fourth compressor 924, which acts as a cold compressor (effectively replacing the cold compressor 620 in the cold compressor/recuperator 600 of FIG. 6). The cooling provided to the CO₂ cooler 922 provides a cold compressed gaseous stream 934 for delivery to the downstream recuperator 904.

The downstream recuperator 904 may include a less complex multi-stream heat exchanger 936 having a plurality of fluid flow passages 938 each in thermal communication with at least one other passage in the plurality of passages. The plurality of fluid flow passages 938 includes an inlet passage 944 connected to receive the cold compressed gaseous stream 934 from the fourth compressor 924. The heat exchanger 936 also includes a passage 944 for receiving the CO₂ depleted gaseous stream 118 from the CO₂ separator 106 as a coolant, which is discharged from the passage as the CO₂ depleted gaseous stream outlet 120. As shown in FIG. 1A, a portion 122 of this stream may be optionally mixed with the gaseous input stream 108 to dilute the stream and lower the overall CO₂ concentration to within the target CO₂ concentration range for the apparatus 900.

The heat exchanger 936 further includes a passage 942 for receiving CO₂ coolant from the cold CO₂ reservoir 926 as a coolant. The CO₂ coolant may be first pressurized to a supercritical pressure and temperature by a supercritical pressurizer 946 and then connected through the passage 942 to provide cooling of the heat exchanger 936. The CO₂ coolant discharged from the passage 942 forms the supercritical CO₂ outlet stream 128.

The cold compressed gaseous stream 934 passes through a passage 944, where the stream is cooled by the respective coolants passing through the passages 940 and 942. A significant proportion of water within the cold compressed gaseous stream 934 may have already been removed in the operational CO₂ cooler 922, such that the stream delivered to the heat exchanger 936 should not cause any significant frosting of water in the passage 944. Consequently, the complexity normally associated with cycling the heat exchangers 804 and 806 shown in FIG. 8A between being operational and in recovery mode may be eliminated.

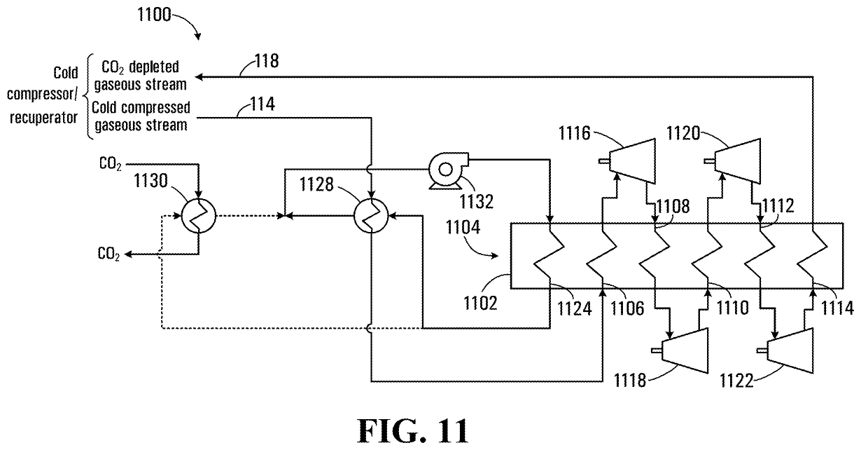

Referring to FIG. 10A, an implementation of the CO₂ separator 106 is shown generally at 1000 and includes an operational heat exchanger 1002 and a recovery heat exchanger 1004. The heat exchanger 1002 and the heat exchanger 1004 may be each configured as multi-stream heat exchangers. The operational heat exchanger 1002 includes a plurality of fluid flow passages 1006, each passage being in thermal communication with at least one other passage in the plurality of passages. The cold compressed gaseous stream 114 is received from the cold compressor/recuperator 104 and channeled through a first passage 1008, which acts as a first heat exchanger for cooling the cold compressed gaseous stream. As disclosed above, the cold compressed gaseous stream 114 may have a temperature of about −58 °C and a pressure of about 45 bar and the additional cooling within the first heat exchanger passage 1008 further reduces the temperature of this stream to cause desublimation of CO₂ within the passage. The first heat exchanger passage 1008 may alternatively be referred to as a “frosting heat exchanger”, in that the heat exchanger causes formation of a CO₂ frost within the heat exchanger passage. Under these conditions, gaseous CO₂ in the cold compressed gaseous stream 114 undergoes a phase transition directly to solid, which will accumulate as a frost within the passage 1008. The stream discharged from the first heat exchanger passage 1008 thus has a reduced concentration of CO₂ due to the desublimation of CO₂ and may be referred to as a CO₂ depleted gaseous stream.

Cooling for the heat exchanger 1002 may be provided by expanding the CO₂ depleted gaseous stream in one or more expanders. The expansion or reduction in pressure causes a corresponding reduction in temperature of the gaseous stream. An expander 1020 may be implemented as an expansion turbine, through which the highly compressed CO₂ depleted gaseous stream is expanded to extract mechanical work via a shaft 1028. The extraction of mechanical work further cools the CO₂ depleted gaseous stream for use as a coolant in the heat exchanger 1002. The mechanical work provided to the expander 1020 is converted into a torque on the shaft 1028, which may be used to drive one or more compressors (such as the compressor 620 shown in FIG. 6 or the compressor 934 shown in FIG. 9).

The CO₂ depleted gaseous stream may be received at the expander 1020 via a second heat exchanger passage 1010 connected between the outlet of the first heat exchanger 1008 and the expander. The second heat exchanger passage 1010 acts as a second heat exchanger and is configured to reheat the CO₂ depleted gaseous stream prior to delivery to the expander 1020 in order to reduce the possibility of CO₂ frosting within or downstream of the expander due to the cooling effect of the work extraction. The CO₂ depleted gaseous stream discharged from the first heat exchanger passage 1008 would generally be at a temperature well below the −58 °C. For example, the temperature of the CO₂ depleted gaseous stream leaving the passage 1008 may be at about −113 °C, which would most likely cause residual gaseous CO₂ in the stream to desublimate and deposit as frost within the expander 1020, or in tubing directly downstream of expander 1020, if delivered directly to the expander. Accumulation of frost within the expander 1020 or in tubing downstream of the expander is undesirable and could potentially impact ongoing operation of the system. This condition is therefore prevented by warming the CO₂ depleted gaseous stream before delivery to the expander 1020. The temperature of the gaseous stream delivered to the expander 1020 may be about −69 °C and may be cooled to about −99 °C within the expander 1020. The stream is then discharged via another passage 1012 within the plurality of fluid flow passages 1006. The CO₂ depleted gaseous stream flowing through the passage 1012 receives heat transferred from other passages in the plurality of fluid flow passages 1006, thus providing cooling for first heat exchanger passage 1008.

A series of four expanders are shown including the expander 1020 described above and second, third and fourth expanders 1022, 1024, and 1026. The CO₂ separator 1000 may be implemented with a lesser or greater number of expanders. Each successive expander 1022-1026 is connected downstream of the preceding expander to receive, expand, and deliver the coolant flow through at least one passage of the plurality of fluid flow passages 1006 in the multi-stream heat exchanger 1002 and to deliver the stream as a coolant to the next passage 1006 in the heat exchanger 1002 (i.e. within respective passages 1014-1018).

Within the heat exchanger 1002, the streams flowing through passages 1010, 1012, 1014, 1016, and 1018 will generally be colder than the cold compressed gaseous stream 114 flowing through the passage 1008. The streams flowing through each of the passages 1012-1018 follow the respective expanders 1020-296, which cool these streams. Additionally the stream received in the second heat exchanger passage 1010 will have been cooled int the first heat exchanger passage 1008. The streams flowing through these passages thus act as coolant streams that transfer heat from the cold compressed gaseous stream causing the temperature of the cold compressed gaseous stream to be lowered below the freezing point of CO₂.

Referring to FIG. 10B, the heat exchanger 1002 may be configured as a shell and tube heat exchanger 1050 including a shell 1052 defines an interior volume 1054. A plurality of tubes 1056 extend through the interior volume 1054. The interior volume 1054 includes an inlet 1058 and an outlet 1060, which together act as the first heat exchanger passage 1008. The plurality of tubes 1056 act as the remaining passages 1010-1018 for heat exchanger. The streams flowing through the plurality of tubes 1056 are all in thermal communication with the cold compressed gaseous stream 114 flowing through the shell 1052. The CO₂ would thus deposit on the outside of the tubes 1056.

The first heat exchanger passage 1008 may be implemented as a tube in thermal communication with other tubes carrying the colder streams and the CO₂ would then deposit within first heat exchanger passage tube.

A pressure ratio for each expander may be expressed as a ratio between the pressure P; at the inlet of the expander and the pressure Pₒ at the outlet of the expander (i.e. Pᵢ/Pₒ). An expander configured for a larger pressure ratio will thus cause a larger reduction in the pressure of the expanding gaseous stream. In general, the temperature at which CO₂ undergoes a desublimation phase change from gas to solid increases with reducing pressure. As such, when the gaseous stream is expanded within in each of the expanders 1022-1026, the pressure of the stream is reduced and the temperature at which frosting occurs will increase accordingly. An expander configured for large pressure ratio may thus cause sufficient pressure reduction to raise the temperature at which frosting occurs to above the temperature of the gaseous stream, thus causing undesirable frosting within the expander. Each successive expander 1022-1026 may be configured to have an outlet temperature that is colder than the outlet temperature of an immediate upstream expander.

The pressure ratio Pᵢ/Pₒ for the first and second expanders 1020 and 1022 may be about 1.8 while the pressure ratio for the third and fourth expanders 1022 and 1024 may be about 3.7. In the expanders 1020 and 1022 configured for a pressure ratio of 1.8, the overall temperature reduction through the expander may be held to about 30 °C. In the later expanders 1024 and 1026 configured for a larger pressure ratio of 3.7, the temperature reduction due to the large drop in pressure may be over 50 °C without risking frosting in the expander or any downstream tubing.

The CO₂ depleted gaseous stream 118 discharged from the passage 1018 may be regarded as a clean gaseous stream, although the stream may still contain a trace CO₂ concentration. In the system 100 shown in FIG. 1A, the stream 118 is further used as a coolant in the cold compressor/recuperator 104 prior to being discharged as the CO₂ depleted gaseous stream outlet 120, as described above.

CO₂ desublimation within the first heat exchanger passage 1008 of the heat exchanger 1002 will eventually cause restriction or obstruction of the passage. After some period of time the operational heat exchanger 1002 may be taken out of operation and the recovery heat exchanger 1004 may be configured as the operational heat exchanger. In FIG. 10A, the recovery heat exchanger 1004 is either similar to or identical to the operational heat exchanger 1002 and includes a plurality of fluid flow passages 1030 in including passages 1032-1042 that correspond to the passage 1008-1018 of the operational heat exchanger 1002. When the heat exchanger 1002 is configured as a recovery heat exchanger, the passage 1032 is disconnected from the cold compressed gaseous stream 114 and the passage 1042 is not connected to discharge of the CO₂ depleted gaseous stream 118. No expanders are connected to the recovery heat exchanger 1004. Under these conditions, the heat exchanger 1002 will no longer be cooled in preparation for removal of desublimated CO₂ accumulated within the passage 1032 during previous operation of the heat exchanger 1004.

The passage 1032 of the recovery heat exchanger 1004 may be connected to receive a CO₂ flow from the hot CO₂ reservoir 928 or directly from the cold compressor/recuperator 104. As noted above in connection with FIG. 9, in this context the terms “hot” and “cold” are used in a relative sense, in that the hot CO₂ reservoir 928 contains CO₂ at a higher temperature than the cold CO₂ reservoir 926. The CO₂ in the cold CO₂ reservoir 926 may be at a temperature of about −46 °C and a pressure of about 8 bar while the CO₂ in the hot CO₂ reservoir 928 may be about 10 °C warmer and at a pressure of 12 bar. The desublimated CO₂ frost that had previously accumulated within the passage 1032 will thus melt into the CO₂ delivered from the hot CO₂ reservoir 928 and will be carried out of the passage to the cold CO₂ reservoir 928. As disclosed above, the hot CO₂ reservoir 928 may be omitted and the return CO₂ stream 126 may be delivered directly to the passage 1032 of the heat exchanger 1004.

In the system 100 shown in FIG. 1A and the cold compressor/recuperator 600 shown in FIG. 6, the CO₂ stream 124 is taken from the cold CO₂ reservoir 926 and is returned to the hot CO₂ reservoir 928 as the return CO₂ stream 126. The CO₂ from the hot CO₂ reservoir 928 is then cooled in the passage 1032 and delivered to the cold CO₂ reservoir 926 as described above and may again be used as a coolant in the cold compressor/recuperator 104.

After a period of time, when all of the desublimated CO₂ has been melted into the CO₂ stream, the passage 1032 may be disconnected from the hot CO₂ reservoir 928 and cold CO₂ reservoir 926. The recovery heat exchanger 1004 may then be returned to the operational state. The recovery heat exchanger 1004 may be re-cooled prior to being placed back in service as the operational heat exchanger by passing a portion of one or more of the cold streams exiting the passages 1010-1018 through the heat exchanger. Once the recovery heat exchanger 1004 is cooled to a temperature close to the desired operating temperature, the currently operational heat exchanger 1002 may be taken out of service and placed in the recovery mode. The recovery heat exchanger 1004 is then connected to the cold compressed gaseous stream 114 and the expanders 1020-1026 and becomes the currently operational heat exchanger. The operation heat exchanger 1004 may be in service accumulating desublimated CO₂ for several hours prior to being taken out of service and placed in the recovery state. The accumulated solid CO₂ may then be removed, which may take a few hours. The re-cooling process follows and may also take a few hours. In one example, each heat exchanger may be operational for between about 2 and 10 hours, followed by a CO₂ removal period of about 30 minutes to about 2 hours and then a re-cooling period of about 2 to 6 hours before being placed back in service. In other examples, additional heat exchangers may be added and the various time periods may be adjusted such that more than one heat exchanger is in operation, and one or more heat exchangers are either having CO₂ removed or re-cooling prior to resuming operation.

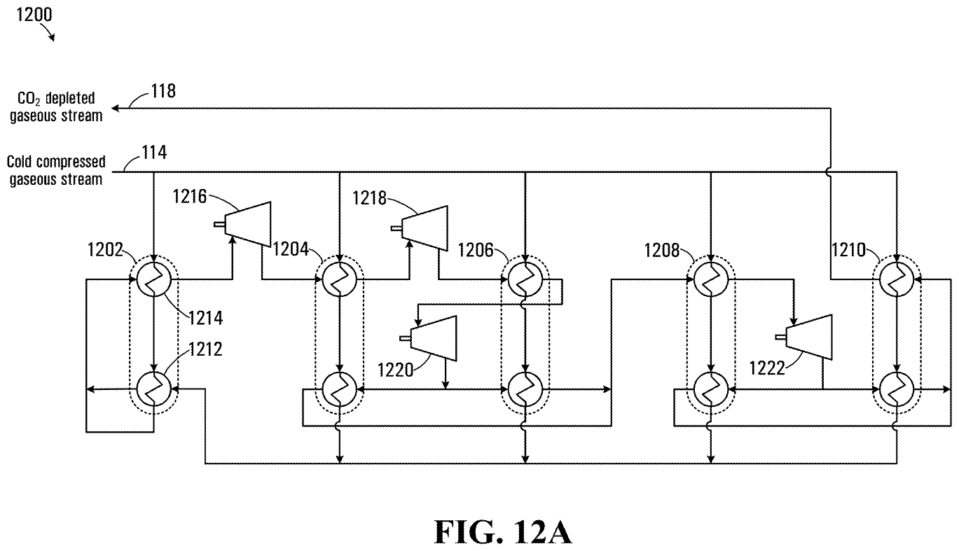

Referring to FIG. 11, a CO₂ separator is shown generally at 1100. The CO₂ separator 1100 includes a multi-stream heat exchanger 1102, which includes a plurality of fluid flow passages 1104. The plurality of fluid flow passages 1104 include passages 1106, 1108, 1110, 1112 and 1114 that generally correspond to the passages 1010-1018 of the heat exchanger 1002 shown in FIG. 10A. The CO₂ separator 1100 also includes successive expanders 1116, 1118, 1120, and 1122, connected between respective passages in the passages 1106-1114. The plurality of fluid flow passages 1104 include at least one additional passage 1124. The CO₂ separator 1100 further includes an operational heat exchanger 1128 and a recovery heat exchanger 1130. The operational heat exchanger 1128 may be implemented as a shell and tube heat exchanger configured to exchange thermal energy between two separated fluid flows. Similarly, the recovery heat exchanger 1130 may be a shell and tube heat exchanger configured to exchange thermal energy between two separated fluid flows.

The passage 1124 is connected to receive a heat exchange fluid delivered from the heat exchanger 1128 via a pump or blower 1132. The heat exchange fluid flowing through the passage 1124 of the multi-stream heat exchanger 1102 is cooled by the gaseous streams flowing through the fluid passages 1108-1114 that are in turn cooled by the successive expanders 1116-1122. The heat exchange fluid is then returned to the heat exchanger 1128 as a coolant. The heat exchange fluid may be a liquid such as liquid propane or a gas such as nitrogen in a gaseous or supercritical state.

The operational heat exchanger 1128 is connected to receive the cold compressed gaseous stream 114 from the cold compressor/recuperator 104 (shown in FIG. 1A) and to deliver the stream to the heat exchanger 1106. The heat exchanger 1128 is cooled by heat exchange fluid received from the passage 1124, which is returned to the multi-stream heat exchanger 1102 via the pump or blower 1132. The cold compressed gaseous stream 114 is cooled in the heat exchanger 1128 causing CO₂ within the stream to desublimate as a frost within the heat exchanger to provide a CO₂ depleted gaseous stream which is delivered to the passage 1106 of the multi-stream heat exchanger 1102. As described above, the passage 1106 functions to warm the gaseous stream before being delivered to the expander 1116, which reduces the possibility of frosting occurring within the expander. The remaining successive expanders 1118-1122 and passages 1108-1114 operate as described above in connection with FIG. 10A and provide cooling for the multi-stream heat exchanger 1102.

The recovery heat exchanger 1130 is disconnected from the cold compressed gaseous stream 114 and connected to receive the CO₂ stream from the hot CO₂ reservoir 928 (shown in FIG. 10A) or directly from the cold compressor/recuperator 104, which liquifies the desublimated CO₂ into the stream for delivery to the cold CO₂ reservoir 926 (FIG. 10A). When the operational heat exchanger 1128 is about to be taken out of operation, the recovery heat exchanger 1130 may be disconnected from the CO₂ flows and connected to receive a portion of the coolant flow from the passage 1124, as shown by the broken lines in FIG. 11. The heat exchange fluid re-cools the recovery heat exchanger 1130 to prepare the heat exchanger for operation in place of the operational heat exchanger 1128. The recovery heat exchanger 1130 may be cooled by passing the CO₂ depleted gaseous stream 118 through the heat exchanger.

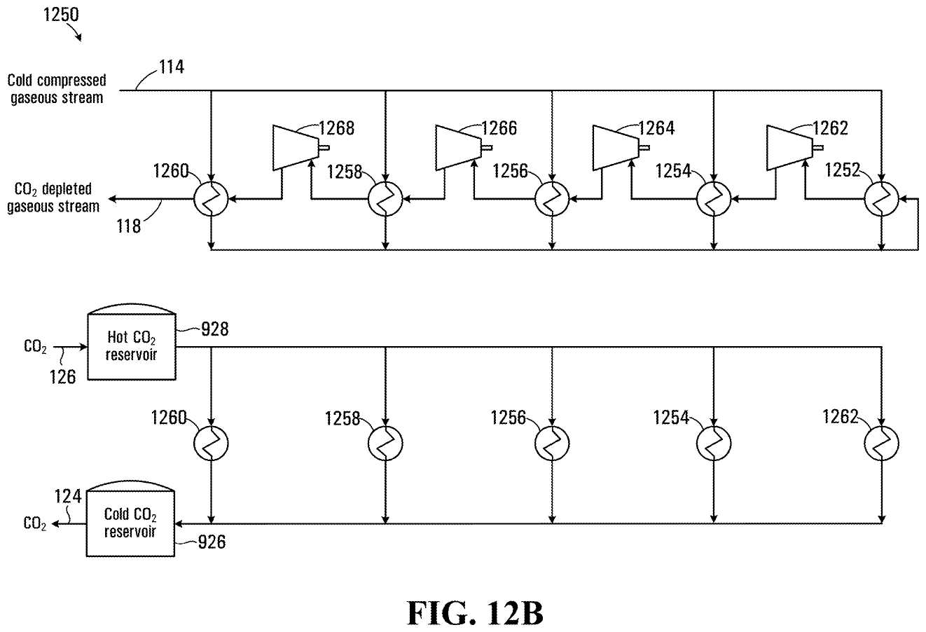

Referring to FIG. 12A, a CO₂ separator is shown generally at 1200. The CO₂ separator 1200 includes a plurality of individual heat exchangers 1202, 1204, 1206, 1208, and 1210. Each of the heat exchangers 1202-1210 includes a pair of two-steam heat exchangers connected to receive a portion of the cold compressed gaseous stream 114. The heat exchangers 1202-1210 are cooled to cause CO₂ desublimation within the heat exchangers. Cold CO₂ depleted streams from the heat exchanger are discharged and connected through a first heat exchanger 1212 within the heat exchanger 1202, where the cold gaseous stream is warmed. This stream is then passed through a second heat exchanger 1214 within the heat exchanger 1202 for further warming before delivering the stream to a first expander 1216 of a series of expanders 1216-1222. The warming of the stream prior to expansion prevents CO₂ desublimation and frost accumulation within the expander 1216. Each expander 1216-1222 cools the stream and then passes the stream through one or more heat exchangers within the plurality of heat exchanger 1204-1210. The stream discharged from first heat exchanger heat exchanger 1210 provides the CO₂ depleted gaseous stream 118.

Referring to FIG. 12B, a CO₂ separator is shown generally at 1250. The CO₂ separator 1250 includes a plurality of heat exchangers 1252, 1254, 1256, 1258, and 1260 each having an inlet and an outlet. The inlet of each heat exchanger is connected to receive a portion of the cold compressed gaseous stream 114. Each of the heat exchangers 1252-1260 is configured to further cool the cold compressed gaseous stream 114 and to cause desublimation of CO₂ within the heat exchanger. The desublimation of CO₂ from the cold compressed gaseous stream in each heat exchanger successively reduces the concentration of CO₂ in the gaseous stream thus producing a CO₂ depleted gaseous stream 118. The respective outlets of each of the plurality of heat exchangers 1252-1260 may be connected to combine and deliver the CO₂ depleted gaseous streams as a coolant to a first heat exchanger 1252 in the plurality of heat exchangers. The CO₂ separator 1250 also includes a plurality of expanders 1262, 1264, 1266, and 1268 connected to receive and expand the coolant to extract mechanical work thereby further cooling the coolant for delivery to successive heat exchangers 1254-1260 following the first heat exchanger 1252.

The CO₂ depleted streams from each of the heat exchangers 1252-1260 are thus collected and delivered to the first heat exchanger 1252 for cooling the cold compressed gaseous stream delivered to the inlet of the first heat exchanger 1252. The cooling causes desublimation of CO₂ within the first heat exchanger 1252 but results in an increase in the coolant temperature. The expander 1262 receives and further cools the coolant prior to delivery to the successive heat exchanger 1254 to facilitate further cooling for desublimation of CO₂ within the successive heat exchanger. Each successive expander 1264-1268 similarly re-cools the coolant to facilitate cooling for desublimation of CO₂ within the successive heat exchangers 1256, 1258, and 1260. The cold compressed gaseous stream may thus be received in parallel at the respective inlets of the plurality of heat exchangers 1252-1260 while the coolant discharged from the respective outlets is connected to flow serially through the first heat exchanger 1252 and the successive heat exchangers 1254-1260 via the respective expanders 1262-1268.

The last heat exchanger 1260 in the plurality of heat exchangers is connected to deliver the coolant to the cold compressor/recuperator 104 (shown in FIG. 1A) for recuperating thermal cooling energy from the coolant prior to discharging the coolant to the atmosphere as the CO₂ depleted gaseous stream outlet 120.

During operation, CO₂ desublimation within the heat exchangers 1252-1260 will eventually cause restriction or obstruction of the heat exchangers. Each of the plurality of heat exchangers 1252-1260 are configurable as a respective recovery heat exchanger 1252′-1260′ by disconnecting from receiving the cold compressed gaseous stream thereby causing warming of the recovery heat exchanger to facilitate removal of desublimated CO₂ as a fluid. As described above in connection with FIG. 10A, hot CO₂ is delivered to the recovery heat exchangers 1252′-1260′ from the reservoir 928 and returned to a cold CO₂ reservoir 1046. Desublimated CO₂ frost that had previously accumulated within the heat exchangers 1252′-1260′ will thus melt into the CO₂ delivered from the hot CO₂ reservoir 928 or directly from the cold compressor/recuperator 104 and will be carried out of the passage to the cold CO₂ reservoir 926. In practice, when the heat exchangers 1252-1260 are configured as recovery heat exchangers 1252′-1260′, another set of heat exchangers may be configured as operational heat exchangers to continue processing the cold compressed gaseous stream 114.

After a period of time, when all of the desublimated CO₂ has been melted into the resulting CO₂ stream, the recovery heat exchangers 1252′-1260′ may be disconnected from the hot CO₂ reservoir 928 and cold CO₂ reservoir 1046 and returned into the operational state. The recovery heat exchangers 1252′-1260′ may first be re-cooled prior to being placed back in service as the operational heat exchanger by passing a portion of the coolant from the operational heat exchangers through the recovery heat exchangers 1252′-1260′. This re-cooling of the recovery heat exchangers 1252′-1260′ prepares the heat exchangers for further operation in the desublimation of CO₂ when the recovery heat exchangers are redeployed as operation heat exchangers.

As described above for the embodiments shown in FIG. 10A and FIG. 11, one or more of the heat exchangers 1202-1210 may be removed from operation for a period of time to remove accumulated desublimated CO₂ frost while the remaining heat exchangers remain operational.

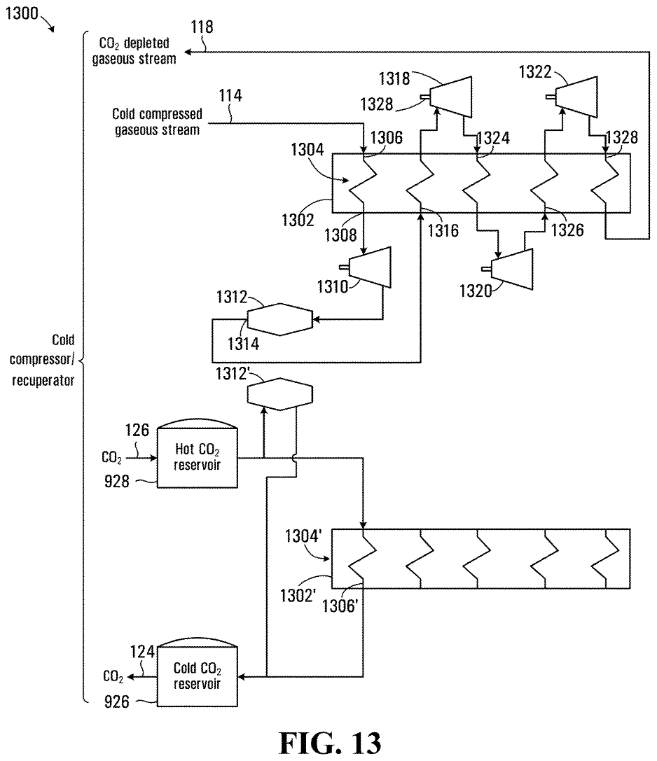

Referring to FIG. 13, an implementation of the CO₂ separator 106 is shown generally at 1300. The CO₂ separator apparatus 1300 includes a heat exchanger 1302, which is configured as a multi-stream heat exchanger having a plurality of heat exchanger passages 1304 in thermal communication with at least one other passage in the plurality of passages. The plurality of heat exchanger passages 1304 include a first heat exchanger passage 1306 connected to receive the cold compressed gaseous stream 114. The cold compressed gaseous stream 114 is cooled within the first heat exchanger passage 1306 to a sufficiently low temperature to cause desublimation of CO₂ within the passage, thereby discharging a CO₂ depleted gaseous stream at an outlet 1308 of the first heat exchanger passage 1306. The CO₂ depleted gaseous stream is delivered to an expander 1310 connected to the outlet 1308. The expander 1310 is configured to expand the CO₂ depleted gaseous stream while extracting mechanical work thereby further cooling the CO₂ depleted gaseous stream. The CO₂ separator apparatus 1300 includes a frost catcher 1312 connected downstream of the expander 1310 to receive the further cooled CO₂ depleted gaseous stream. The frost catcher 1312 is configured to cause further desublimation of remaining CO₂ within the CO₂ depleted gaseous stream, which deposits within the frost catcher. The frost catcher 1312 includes an outlet 1314 for discharging the further cooled CO₂ depleted gaseous stream for use as a coolant in the passage 1316 for cooling the heat exchanger 1302 and particularly the first heat exchanger passage 1306.

The CO₂ separator apparatus 1300 includes a further plurality of expanders 1318, 1320 and 1322. The expander 1318 is connected to receive the gaseous stream from the passage 1316 and each of the successive expanders 1320 and 1322 are serially connected via passages 1324 and 1326 to receive and expand the gaseous stream from a previous respective heat exchanger passage. Each expander 1318, 1320 and 1322 provides additional cooling of the CO₂ depleted gaseous stream for use as a coolant in the heat exchanger 1302 by extracting mechanical work. For example, the further cooled CO₂ depleted gaseous stream from the frost catcher 1312 is connected through the heat exchanger passage 1316, which cools the heat exchanger 1302. The expander 1318 then receives and cools the CO₂ depleted gaseous stream from the heat exchanger passage 1316 and re-cools the stream for delivery to the heat exchanger passage 1324. The expander 1322 is connected to deliver the CO₂ depleted gaseous stream to the 1328, which acts as an outlet passage for discharging the CO₂ depleted gaseous stream 118 from the CO₂ separator apparatus 1300.

The CO₂ depleted gaseous stream at the outlet of the frost catcher 1312 will have had a significant proportion of CO₂ removed by desublimation within the cooled first heat exchanger passage 1306 and in the frost catcher 1312. The CO₂ depleted gaseous stream passing through expander 1318 will thus have a sufficiently low remaining concentration of CO₂ to avoid any significant CO₂ desublimation within the expander 1318 or in tubing connecting the expander to the heat exchanger passage 1324. Similarly, due to the low CO₂ concentration minimal CO₂ desublimation should occur within the remaining expanders 1320, 1322 or in the tubing connecting between these expanders and the respective heat exchanger passages 1324 and 1328.

Desublimated CO₂ thus accumulates primarily in the first heat exchanger passage 1306 and in the frost catcher 1312. As described above in connection with FIG. 10A, the CO₂ separator apparatus 1300 also includes a recovery heat exchanger 1302′ having a plurality of heat exchanger passages 1304′ corresponding to the passages 1304 of the operational heat exchanger 1302. When the heat exchanger 1302′ is configured as a recovery heat exchanger, the passage 1306′ is disconnected from the cold compressed gaseous stream 114 and the expanders 1310, 1318, 1320, and 1322 are disconnected from the heat exchanger 1302′ and connected to the operational heat exchanger 1302. Under these conditions, the heat exchanger 1302′ no longer receives a coolant and will thus warm up to facilitate removal of desublimated CO₂ accumulated within the passage 1306′. To facilitate the melting and removal of solid CO₂, CO₂ is delivered from the hot CO₂ reservoir 926, or directly from the cold compressor/recuperator 104 through the heat exchanger passage 1306′. This causes solid CO₂ to melt into the resulting CO₂ flow and is returned to the cold CO₂ reservoir 926 for storage.

The CO₂ separator apparatus 1300 may include the frost catcher 1312 configured as an operational frost catcher and also includes at least one a recovery frost catcher 1312′. The frost catchers 1312 and 1312′ are configured to be interchanged by periodically disconnecting the operational frost catcher from receiving the CO₂ depleted gaseous stream and configuring the previously operational frost catcher in the recovery mode. The recovery mode permits warming of the recovery frost catcher 1312′ for removal of desublimated CO₂ as a fluid. A flow of CO₂ is diverted from the hot CO₂ reservoir 928 or directly from the cold compressor/recuperator 104 to flow through the recovery frost catcher 1312′ causing desublimated solid CO₂ to melt into the CO₂ diverted stream. The resulting CO₂ fluid is then returned to the cold CO₂ reservoir 926 for storage.

After most or all of the desublimated solid CO₂ has been removed from the recovery heat exchanger 1302′ and the recovery frost catcher 1312′, the CO₂ flow may be disconnected. At this time, a portion of the cold compressed gaseous stream 114 may be diverted through the first heat exchanger passage 1306 and the frost catcher 1312′ to re-cool the heat exchanger 1302′ and the recovery frost catcher in preparation for interchanging with the respective operational heat exchanger 1302 and operational frost catcher 1312.

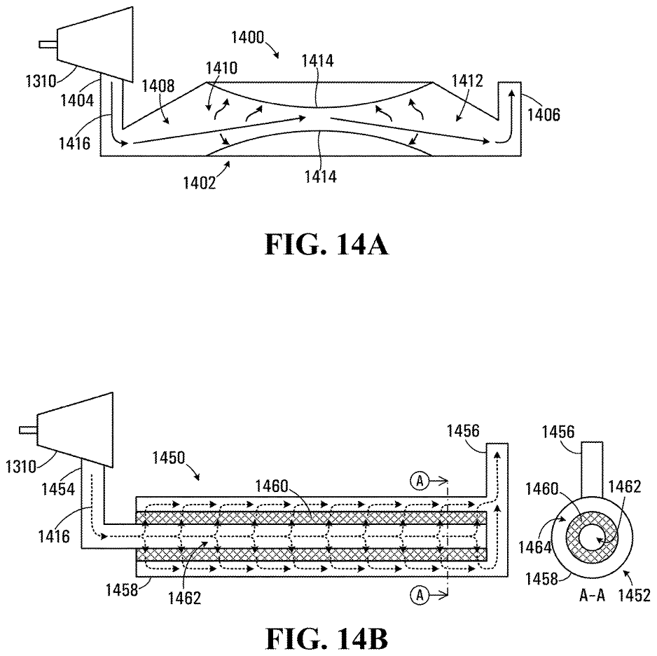

Referring to FIG. 14A, an implementation of the frost catcher 1312 in the CO₂ separator apparatus 1300 is shown schematically at 1400. The frost catcher 1400 includes a duct 1402 having an inlet 1404 connecting directly to an outlet of the expander 1310. The frost catcher 1400 also includes an outlet 1406 for connecting to the heat exchanger passage 1316 of the heat exchanger 1302. The duct 1402 has an expanding channel 1408 followed by a converging channel 1412. A central portion 1410 of the duct 1402 is constricted by a baffle 1414 extending inwardly from walls of the duct 1402.

The expander 1310 further lowers the temperature of the cold compressed gaseous stream 114 to temperatures at which desublimation of CO₂ may readily occur. High turbulence within the expander 1310 however tends to reduce or eliminate frosting within the expander. Rather, desublimation of CO₂ is more likely to occur in tubes connected directly to the outlet of the expander 1310. A gaseous flow 1416 from the expander 1310 is channeled through the inlet 1404 and allowed to expand into the central portion of 1410 of the duct 1402, where at least a portion of gaseous CO₂ within the gaseous stream desublimates onto surfaces of the baffle 1414. The gaseous flow discharged through the outlet 1406 will thus have a lower CO₂ concentration than the inlet gaseous flow 1416 due to the desublimation that occurs on the baffle 1414.

After a period of time, an accumulation of desublimated CO₂ may cause the central portion 1410 of the duct 1402 in the region of the baffle 1414 to be obstructed and the frost catcher may be disconnected for removal of solid CO₂ as described above in connection with the recovery frost catcher 1312′.

Referring to FIG. 14b, another implementation of the frost catcher 1312 in the CO₂ separator apparatus 1300 is shown schematically at 1450. The CO₂ separator apparatus 1300 is shown at 1452 in a cross-sectional view taken along a line A-A. The frost catcher 1450 includes an inlet 1454 connecting directly to an outlet of the expander 1310. The frost catcher 1450 also includes an outlet 1456 for connecting to the heat exchanger passage 1316. The frost catcher 1450 comprises a cylindrical housing 1458 and a structured fill 1460 in the shape of a cylindrical shell disposed concentrically within the cylindrical housing. A central portion 1462 of the structured fill 1460 is in fluid communication with the inlet 1454 and acts as a central plenum for receiving the gaseous stream and directing flow radially through the structured fill 1460. The cylindrical housing 1458 also defines a peripheral plenum 1464 surrounding the cylindrical housing 1458, which receives and directs the radial gaseous flow toward the outlet 1456. Gaseous CO₂ in the gaseous stream desublimates while passing radially through the structured fill 1460.

The structured fill 1460 may comprise a three dimensional mesh or other material that facilitates radial flow while providing a large surface area on which solid CO₂ can accumulate. The structured fill 1460 by providing many radial flow channels through the fill facilitates a substantial accumulation of solid CO₂ before the fill becomes clogged and needs to be taken out of operation into the recovery mode.

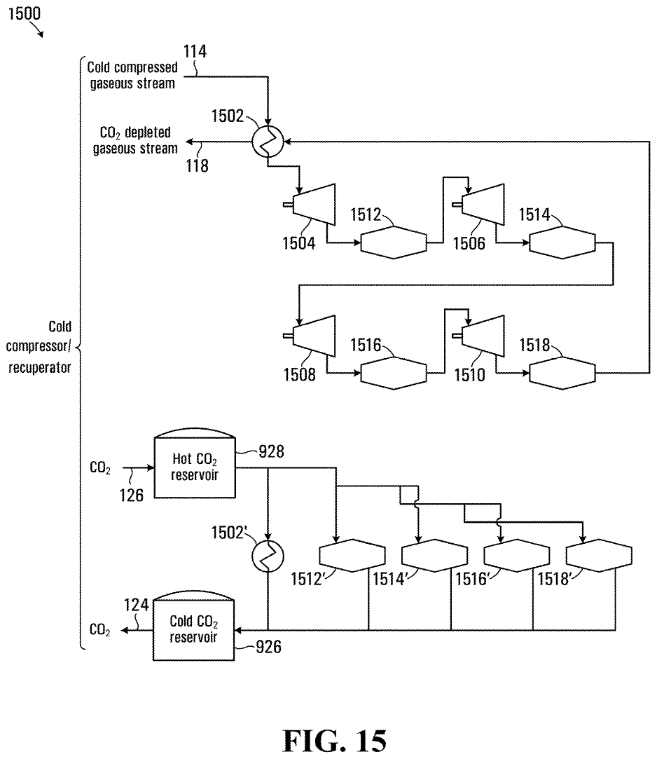

Referring to FIG. 15, a CO₂ separator is shown generally at 1500. The CO₂ separator 1500 includes a heat exchanger 1502 having an inlet connected to receive the cold compressed gaseous stream 114. The heat exchanger 1502 is configured to further cool the cold compressed gaseous stream 114 and to cause desublimation of CO₂ within the heat exchanger.

The CO₂ separator 1250 also includes a plurality of expanders 1504, 1506, 1508, and 1510, which are serially connected to receive and expand the cold compressed gaseous stream 114 to extract mechanical work thereby further cooling the stream to act as a coolant for delivery back to the heat exchanger 1502. Each of the expanders 1506-1510 have a respective connected downstream frost catcher 1512-1518. The heat exchanger 1502 is cooled to a temperature that causes desublimation of gaseous CO₂ in the cold compressed gaseous stream 114, thus reducing the CO₂ concentration in the stream. The successive expanders 1504-1510 each cool the gaseous stream further by expanding and delivering the stream to the respective downstream frost catcher 1512-1518.

The heat exchanger 1502 may have a reduced size and cooling capacity when compared to heat exchangers previously described where a more significant proportion of the CO₂ may be removed by desublimation in the first heat exchanger or first heat exchanger passage. The successive expanders 1504-1510 may be configured to cool the gaseous steam to a temperature that causes a more significant proportion of CO₂ desublimation to occur within the respective downstream frost catchers 1512-1518. The configuration shown in FIG. 15 eliminates the need for a multi-stream heat exchanger such as shown in FIG. 10 and FIG. 11, which may be more difficult to implement than a simple heat exchanger. Additionally, the config of FIG. 15 avoids the potentially more complex network of heat exchangers such as shown in FIG. 12A and FIG. 12B. However, the reduction in implementation complexity may come at the cost of slightly reduced operating efficiency.

The CO₂ separator 1500 also includes a recovery heat exchanger 1502′ and respective recovery frost catchers 1512′, 1514′, 1516′, and 1518′. The recovery heat exchanger 1502′ and recovery frost catchers 1512′, 1514′, 1516′, and 1518 are shown disconnected from the cold compressed gaseous stream 114 to facilitate removal of desublimated CO₂. CO₂ from the hot CO₂ reservoir 928 or from the or directly from the cold compressor/recuperator 104 is passed through the recovery heat exchanger 1502′ and recovery frost catchers 1512′, 1514′, 1516′, and 1518 to cause melting of solid CO₂ within these components. The CO₂ is then returned to the cold CO₂ reservoir 926.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, or within less than 0.01% of the stated value.

While specific embodiments have been described and illustrated, such embodiments should be considered illustrative only and not as limiting the disclosed embodiments as construed in accordance with the accompanying claims.

1-56. (canceled)

57. A CO₂ separator apparatus for extracting carbon dioxide (CO₂) from a cold compressed gaseous stream, the apparatus comprising:
a first heat exchanger connected to receive and further cool the cold compressed gaseous stream to cause desublimation of CO₂ within the first heat exchanger and to produce a CO₂ depleted gaseous stream at an outlet of the first heat exchanger;
an expander configured to expand the CO₂ depleted gaseous stream while extracting mechanical work thereby cooling the CO₂ depleted gaseous stream to act as a coolant for cooling the first heat exchanger; and
a second heat exchanger connected between the outlet of the first heat exchanger and the expander, the second heat exchanger being configured to reheat the CO₂ depleted gaseous stream prior to delivery to the expander to reduce formation of solids within or downstream of the expander.

58. The apparatus of claim 57, wherein the cold compressed gaseous stream is generated upstream of the CO₂ separator by cooling a hot compressed gaseous stream and wherein at least a portion of the CO₂ depleted gaseous stream is returned upstream to act as a coolant for cooling the hot compressed gaseous stream after acting as a coolant for cooling the first heat exchanger.

59. The apparatus of claim 57 wherein the first heat exchanger is configured to transfer heat to the second heat exchanger for reheating the CO₂ depleted gaseous stream in the second heat exchanger.

60. The apparatus of claim 59 wherein the first heat exchanger comprises a plurality of fluid flow passages in thermal communication and wherein one of the plurality of passages acts as the first heat exchanger and another of the plurality of passages acts as the second heat exchanger.

61. The apparatus of claim 57 wherein the expander comprises a plurality of successive expanders, each successive pair of expanders in the plurality of successive expanders having a heat exchanger connected between an outlet of a first expander and an inlet of a second expander in the successive pair of expanders, each heat exchanger being configured to reheat the CO₂ depleted gaseous stream prior to delivery to the next successive expander.

62. The apparatus of claim 61 wherein at least one heat exchanger of the heat exchangers connected between an outlet of a first expander and an inlet of a second expander is configured to receive and further cool a portion of the cold compressed gaseous stream to cause desublimation of CO₂.

63. The apparatus of claim 61 further comprising an additional heat exchanger connected to an outlet of a last expander in the plurality of successive expanders, the additional heat exchanger being configured to reheat the CO₂ depleted gaseous stream prior to discharge from the apparatus.

64. The apparatus of claim 61 wherein at least one expander in the plurality of successive expanders has an outlet temperature that is colder than an outlet temperature of an immediate upstream expander in the plurality of successive expanders.

65. The apparatus of claim 61 wherein at least one expander in the plurality of successive expanders has a pressure ratio that is greater than a pressure ratio associated with an immediate upstream expander in the plurality of successive expanders.

66. The apparatus of claim 57 wherein the further cooling of the cold compressed gaseous stream is provided solely by the CO₂ depleted gaseous stream.

67. The apparatus of claim 57 wherein the first heat exchanger comprises a warmer portion and a colder portion, and wherein a mass-flow-rate-weighted specific heat capacity of coolant flowing in the warmer portion is higher than a mass-flow-rate-weighted specific heat capacity of coolant flowing in the colder portion.

68. The apparatus of claim 57 wherein the first heat exchanger comprises a plurality of coolant inlets.

69. The apparatus of claim 57 wherein the second heat exchanger comprises at least one passage within a multi-stream heat exchanger including a plurality of fluid flow passages, each passage being in thermal communication with at least one other passage in the plurality of fluid flow passages, and wherein the expander comprises a plurality of expanders, each expander being connected between successive passages in the multi-stream heat exchanger to provide cooling for the multi-stream heat exchanger.

70. The apparatus of claim 69 wherein the first heat exchanger comprises at least one passage in the plurality of fluid flow passages within the multi-stream heat exchanger.

71. The apparatus of claim 69 wherein the coolant comprises a heat transfer fluid circulating between the first heat exchanger and at least one passage in the plurality of fluid flow passages within the multi-stream heat exchanger, and wherein the heat transfer fluid is cooled within the multi-stream heat exchanger.

72. The apparatus of claim 57 wherein the second heat exchanger is configured to be heated by a heat transfer fluid circulating between the first heat exchanger and second heat exchanger.

73. The apparatus of claim 72 wherein the heat transfer fluid is circulated between the first and second heat exchangers using a pump or blower and wherein the pump or blower is connected between an outlet of the first heat exchanger and an inlet of the second heat exchanger.

74. The apparatus of claim 57 wherein no vessel or device configured to perform substantial separation of CO₂ from the CO₂ depleted gaseous stream is disposed between the outlet of the first heat exchanger and the second heat exchanger.

75. The apparatus of claim 57 wherein the first heat exchanger comprises a tube, and wherein the CO₂ desublimation accumulates on an interior surface of the tube.

76. The apparatus of claim 57 wherein the first heat exchanger comprises a shell and tube heat exchanger.

77. The apparatus of claim 57 wherein during operation of the first heat exchanger, desublimated CO₂ accumulates within the first heat exchanger and wherein the first heat exchanger is configurable in a recovery mode during which solid CO₂ is melted to facilitate removal of the solid CO₂.

78. The apparatus of claim 77 wherein the CO₂ separator apparatus comprises:
at least one operational heat exchanger configured in an operational mode to receive and further cool the cold compressed gaseous stream to cause desublimation of CO₂; and
at least one recovery heat exchanger configured in the recovery mode disconnected from receiving the coolant to cause warming of the recovery heat exchanger to facilitate recovery of desublimated CO₂;
wherein the operational heat exchanger and the recovery heat exchanger are configured to be periodically interchanged between the operational mode and the recovery mode.

79. The apparatus of claim 77 wherein the first heat exchanger is further configurable in a re-cooling mode for re-cooling the first heat exchanger prior to being returned to the operational mode.

80. A method for extracting carbon dioxide (CO₂) from a cold compressed gaseous stream, the method comprising:
receiving and further cooling the cold compressed gaseous stream to cause desublimation of CO₂ within a first heat exchanger to produce a CO₂ depleted gaseous stream;
expanding the CO₂ depleted gaseous stream while extracting mechanical work thereby cooling the CO₂ depleted gaseous stream to act as a coolant for cooling the first heat exchanger;
reheating the CO₂ depleted gaseous stream prior to expanding to reduce formation of solids during the expanding.

81. The method of claim 80 further comprising generating the cold compressed gaseous stream upstream of the CO₂ separator by cooling a hot compressed gaseous stream and returning at least a portion of the CO₂ depleted gaseous stream upstream to act as a coolant for cooling the hot compressed gaseous stream after acting as a coolant for cooling the first heat exchanger.

82. The method of claim 80 wherein expanding the CO₂ depleted gaseous stream comprises successively expanding the CO₂ depleted gaseous stream in a plurality of successive expanders and wherein reheating the CO₂ depleted gaseous stream comprises reheating the CO₂ depleted gaseous stream in one or more heat exchangers connected between an outlet of a first expander and an inlet of a second expander in each successive pair of expanders.

83. The method of claim 82 wherein at least one expander in the plurality of successive expanders has an outlet temperature that is colder than an outlet temperature of an immediate upstream expander in the plurality of successive expanders.

84. The method of claim 82 wherein at least one expander in the plurality of successive expanders has a pressure ratio that is greater than a pressure ratio associated with an immediate upstream expander in the plurality of successive expanders.

85. The method of claim 80 wherein the further cooling of the cold compressed gaseous stream is provided solely by the CO₂ depleted gaseous stream.
